(19) United States
(12) Patent Application Publication
(10) Pub. No.: US 2013/0024167 A1
(43) Pub. Date: Jan. 24, 2013

(54) Computer-Implemented Systems And Methods For Large Scale Automatic Forecast Combinations

(71) Applicants: Edward Tilden Blair, Cary, NC (US); Michael J. Leonard, Cary, NC (US); David Bruce Elsheimer, Clayton, NC (US); Jerzy Michal Brzezicki, Cary, NC (US); Kannukuzhiyil Kurien Kurien, Pune (IN); Michael Ryan Chipley, Raleigh, NC (US); Dinesh P. Apte, Pune (IN); Ming-Chun Chang, Cary, NC (US)

(72) Inventors: Edward Tilden Blair, Cary, NC (US); Michael J. Leonard, Cary, NC (US); David Bruce Elsheimer, Clayton, NC (US); Jerzy Michal Brzezicki, Cary, NC (US); Kannukuzhiyil Kurien Kurien, Pune (IN); Michael Ryan Chipley, Raleigh, NC (US); Dinesh P. Apte, Pune (IN); Ming-Chun Chang, Cary, NC (US)

(21) Appl. No.: 13/189,131

(22) Filed: Jul. 22, 2011

(51) Int. Cl. G06F 17/10

(52) U.S. Cl. 703/2

(57) ABSTRACT

Systems and methods are provided for evaluating a physical process with respect to one or more attributes of the physical process by combining forecasts for the one or more physical process attributes, where data for evaluating the physical process is generated over time. A forecast model selection graph is accessed, the forecast model selection graph comprising a hierarchy of nodes arranged in parent-child relationships. A plurality of model forecast nodes are resolved, where resolving a model forecast node includes generating a node forecast for the one or more physical process attributes. A combination node is processed, where a combination node transforms a plurality of node forecasts at child nodes of the combination node into a combined forecast. A selection node is processed, where a selection node chooses a node forecast from among child nodes of the selection node based on a selection criteria.

### TECHNICAL FIELD

This document relates generally to computer-implemented forecasting and more particularly to using multiple forecasts to generate a combined forecast.

### BACKGROUND

Forecasting is a process of making statements about events whose actual outcomes typically have not yet been observed. A commonplace example might be estimation for some variable of interest at some specified future date. Forecasting often involves formal statistical methods employing time series, cross-sectional or longitudinal data, or alternatively to less formal judgmental methods. Forecasts are often generated by providing a number of input values to a predictive model, where the model outputs a forecast. While a well designed model may give an accurate forecast, a configuration where predictions of multiple models are considered when generating a forecast may provide even stronger forecast results.

### SUMMARY

In accordance with the teachings herein, systems and methods are provided for evaluating a physical process with respect to one or more attributes of the physical process by combining forecasts for the one or more physical process attributes, where data for evaluating the physical process is generated over time. In one example, a forecast model selection graph is accessed, the forecast model selection graph comprising a hierarchy of nodes arranged in parent-child relationships. A plurality of model forecast nodes are resolved, where resolving a model forecast node includes generating a node forecast for the one or more physical process attributes. A combination node is processed, where a combination node transforms a plurality of node forecasts at child nodes of the combination node into a combined forecast. A selection node is processed, where a selection node chooses a node forecast from among child nodes of the selection node based on a selection criteria.

As another example, a system for storing evaluating a physical process with respect to one or more attributes of the physical process by combining forecasts for the one or more physical process attributes, where data for evaluating the physical process is generated over time is provided. The system may include one or more data processors and a computer-readable medium encoded with instructions for commanding the one or more data processors to execute steps. In the steps, a forecast model selection graph is accessed, the forecast model selection graph comprising a hierarchy of nodes arranged in parent-child relationships. A plurality of model forecast nodes are resolved, where resolving a model forecast node includes generating a node forecast for the one or more physical process attributes. A combination node is processed, where a combination node transforms a plurality of node forecasts at child nodes of the combination node into a combined forecast. A selection node is processed, where a selection node chooses a node forecast from among child nodes of the selection node based on a selection criteria.

As a further example, a computer-readable storage medium may be encoded with instructions for commanding one or more data processors to execute a method. In the method, a forecast model selection graph is accessed, the forecast model selection graph comprising a hierarchy of nodes arranged in parent-child relationships. A plurality of model forecast nodes are resolved, where resolving a model forecast node includes generating a node forecast for the one or more physical process attributes. A combination node is processed, where a combination node transforms a plurality of node forecasts at child nodes of the combination node into a combined forecast. A selection node is processed, where a selection node chooses a node forecast from among child nodes of the selection node based on a selection criteria.

As an additional example, one or more computer-readable storage mediums may store data structures for access by an application program being executed on one or more data processors for evaluating a physical process with respect to one or more attributes of the physical process by combining forecasts for the one or more physical process attributes, where physical process data generated over time is used in the forecasts for the one or more physical process attributes. The data structures may include a predictive models data structure, the predictive models data structure containing predictive data model records for specifying predictive data models and a forecast model selection graph data structure, where the forecast model selection graph data structure contains data about a hierarchical structure of nodes which specify how the forecasts for the one or more physical process attributes are combined, where the hierarchical structure of nodes has a root node wherein the nodes include model forecast nodes, one or more model combination nodes, and one or more model selection nodes. The forecast model selection graph data structure may include model forecast node data which specifies for the model forecast nodes which particular predictive data models contained in the predictive models data structure are to be used for generating forecasts, model combination node data which specifies for the one or more model combination nodes which of the forecasts generated by the model forecast nodes are to be combined, and selection node data which specifies for the one or more model selection nodes model selection criteria for selecting, based upon model forecasting performance, models associated with the model forecast nodes or the one or more model combination nodes.

### BRIEF DESCRIPTION OF THE FIGURES

FIG. 1 is a block diagram depicting a computer-implemented combined forecast engine.

FIG. 2 is a block diagram depicting the generation of a combined forecast for a forecast variable.

FIG. 3 is a block diagram depicting steps that may be performed by a combined forecast engine in generating a combined forecast.

FIG. 4 depicts an example forecast model selection graph.

FIG. 5 depicts an example forecast model selection graph including selection nodes, combination nodes, and model forecast nodes.

FIG. 6 is a block diagram depicting example operations that may be performed by a combined forecast engine in combining one or more forecasts.

FIG. 7 is a flow diagram depicting an example redundancy test in the form of an encompassing test.

FIG. 8 depicts a forecast model selection graph having a selection node as a root node.

FIG. 9 depicts a forecast model selection graph having a combination node as a root node.

FIG. 10 depicts an example model repository for storing predictive models.

FIG. 11 depicts a link between a forecast model selection graph and a model repository.

FIG. 12 is a diagram depicting relationships among a forecast model selection graph data structure, a models data structure, and a combined forecast engine.

FIG. 13 depicts an example forecast model selection graph data structure.

FIG. 14 depicts an example node record.

FIGS. 15-32 depict graphical user interfaces that may be used in generating and comparing combined forecasts.

FIGS. 33A, 33B, and 33C depict example systems for use in implementing combined forecast engine.

### DETAILED DESCRIPTION

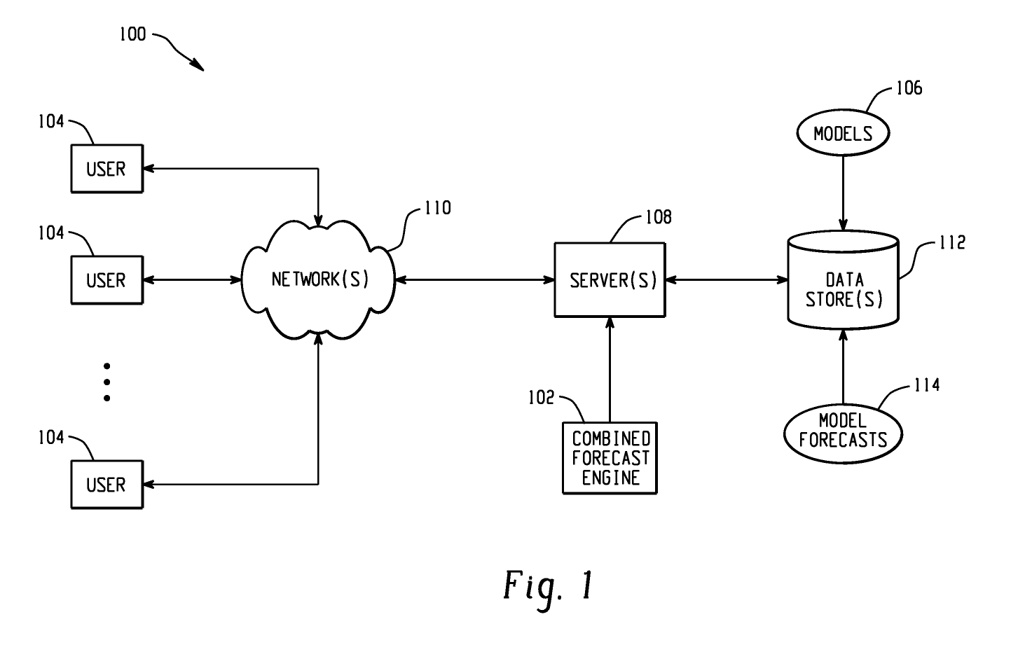

FIG. 1 is a block diagram depicting a computer-implemented combined forecast engine. FIG. 1 depicts a computer-implemented combined forecast engine 102 for facilitating the creation of combined forecasts and evaluation of created combined forecasts against individual forecasts as well as other combined forecasts. Forecasts are predictions that are typically generated by a predictive model based on one or more inputs to the predictive model. A combined forecast engine 102 combines predictions made by multiple models, of the same or different type, to generate a single, combined forecast that can incorporate the strengths of the multiple, individual models which comprise the combined forecast.

For example, a combined forecast may be generated (e.g., to predict a manufacturing process output, to estimate product sales) by combining individual forecasts from two linear regression models and one autoregressive regression model. The individual forecasts may be combined in a variety of ways, such as by a straight average, via a weighted average, or via another method. To generate a weighted forecast, automated analysis of the individual forecasts may be performed to identify weights to generate an optimum combined forecast that best utilizes the available individual forecasts.

The combined forecast engine 102 provides a platform for users 104 to generate combined forecasts based on individual forecasts generated by individual predictive models 106. A user 104 accesses the combined forecast engine 102, which is hosted on one or more servers 108, via one or more networks 110. The one or more servers 108 are responsive to one or more data stores 112. The one or more data stores 112 may contain a variety of data that includes predictive models 106 and model forecasts 114.

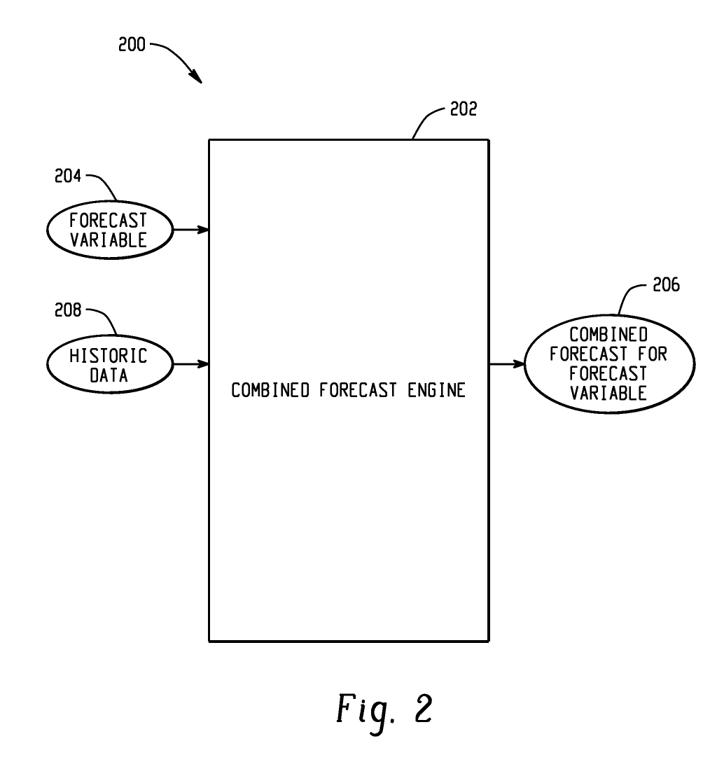

FIG. 2 is a block diagram depicting the generation of a combined forecast for a forecast variable (e.g., one or more physical process attributes). The combined forecast engine 202 receives an identification of a forecast variable 204 for which to generate a combined forecast 206. For example, a user may command that the combined forecast engine 202 generate a combined forecast 206 of sales for a particular clothing item. To generate the combined forecast 206, the combined forecast engine 202 may identify a number of individual predictive models. Those individual predictive models may be provided historic data 208 as input, and those individual predictive models provide individual forecasts based on the provided historic data 208. The combined forecast engine 202 performs operations to combine those individual predictions of sales of the particular clothing item to generate the combined forecast of sales for the particular clothing item.

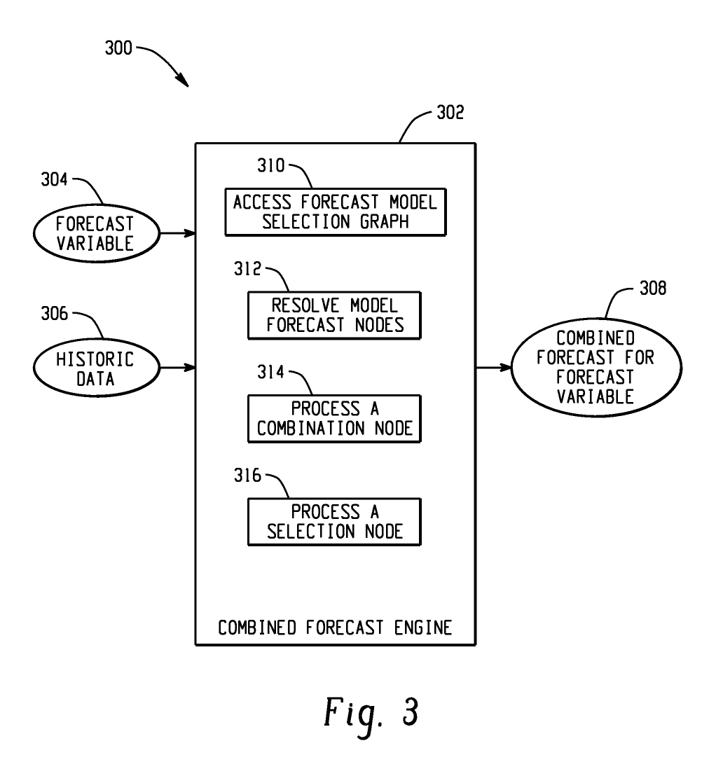

FIG. 3 is a block diagram depicting steps that may be performed by a combined forecast engine in generating a combined forecast. The combined forecast engine 302 receives a forecast variable 304 for which to generate a combined forecast as well as historic data 306 to be used as input to individual predictive models whose predictions become components of the combined forecast 308.

The combined forecast engine 302 may utilize model selection and model combination operations to generate a combined forecast. For example, the combined forecast engine 302 may evaluate a physical process with respect to one or more attributes of the physical process by combining forecasts for the one or more physical process attributes. Data for evaluating the physical process may be generated over time, such as time series data.

At 310, the combined forecast engine accesses a forecast model selection graph. A forecast model selection graph incorporates both model selection and model combination into a decision based framework that, when applied to a time series, automatically selects a forecast from an evaluation of independent, individual forecasts generated. The forecast model selection graph can include forecasts from statistical models, external forecasts from outside agents (e.g., expert predictions, other forecasts generated outside of the combined forecast engine 302), or combinations thereof. The forecast model selection graph may be used to generate combined forecasts as well as comparisons among competing generated forecasts to select a best forecast. A forecast model selection graph for a forecast decision process of arbitrary complexity may be created, limited only by external factors such as computational power and machine resource limits.

A forecast model selection graph may include a hierarchy of nodes arranged in parent-child relationships including a root node. The hierarchy may include one or more selection nodes, one or more combination nodes, and a plurality of model forecast nodes. Each of the model forecast nodes is associated with a predictive model. The combined forecast engine may resolve the plurality of model forecast nodes, as shown at 312. Resolving a model forecast node includes generating a node forecast for the forecast variable 304 using the predictive model for the model forecast node. For example, a first model forecast node may be associated with a regression model. To resolve the first model forecast node, the combined forecast engine 302 provides the historic data 306 to the regression model, and the regression model generates a node forecast for the model forecast node. A second model forecast node may be associated with a human expert prediction. In such a case, computation by the combined forecast engine 302 may be limited, such as simply accessing the human expert's prediction from storage. A third model forecast node may be associated with a different combined model. To resolve the third model forecast node, the combined forecast engine 302 provides the historic data 306 to the different combined model, and the different combined model generates a node forecast for the model forecast node. Other types of models and forecasts may also be associated with a model forecast node.

At 314, the combined forecast engine processes a combination node. In processing a combination node, the combined forecast engine 302 transforms a plurality of node forecasts at child nodes of the combination nodes into a combined forecast. For example, a combination node having three child nodes would have the node forecasts for those three child nodes combined into a combined forecast for the combination node. Combining node forecasts may be done in a variety of ways, such as via a weighted average. A weighted average may weight each of the three node forecasts equally, or the combined forecast engine 302 may implement more complex logic to identify a weight for each of the three node forecasts. For example, weight types may include a simple average, user-defined weights, rank weights, ranked user-weights, AICC weights, root mean square error weights, restricted least squares eights, OLS weights, and least absolute deviation weights.

At 316, the combined forecast engine processes a selection node. In processing a selection node, the combined forecast engine 302 chooses a node forecast from among child nodes of the selection node based on a selection criteria. The selection criteria may take a variety of forms. For example, the selection criteria may dictate selection of a node forecast associated with a node whose associated model performs best in a hold out sample analysis.

As another example, metadata may be associated with models associated with node forecasts, where the metadata identifies a model characteristic of a model. The selection criteria may dictate selection of a node forecast whose metadata model characteristic best matches a characteristic of the forecast variable 304. For example, if the forecast variable 304 tends to behave in a seasonal pattern, then the selection criteria may dictate selection of a node forecast that was generated by a model whose metadata identifies it as handling seasonal data. Other example model metadata characteristics include trending model, intermittent model, and transformed model.

As a further example, the selection criteria may dictate selection of a node forecast having the least amount of missing data. A node forecast may include forecasts for the forecast variable 304 for a number of time periods in the future (e.g., forecast variable at t+1, forecast variable at t+2, . . . ). In some circumstances, a node forecast may be missing data for certain future time period forecasts (e.g., the node forecast is an expert's prediction, where the expert only makes one prediction at t+6 months). If a certain time period in the future is of specific interest, the selection criteria may dictate that a selected node forecast must not be missing a forecast at the time period of interest (e.g., when the time period of interest is t+1 month, the node forecast including the expert's prediction may not be selected).

As another example, the selection criteria may be based on a statistic of fit. For example, the combined forecast engine 302 may fit models associated with child nodes of a selection node with the historic data 306 and calculate statistics of fit for those models. Based on the determined statistics of fit, the combined forecast engine 302 selects the forecast node associated with the model that is a best fit.

The combined forecast engine 302 may continue resolving model forecast nodes 312 and processing combination and selection nodes 314, 316 until a final combined forecast is generated. For example, the combined forecast engine may work from the leaves up to the root in the forecast model selection graph hierarchy, where the final combined forecast is generated at the root node.

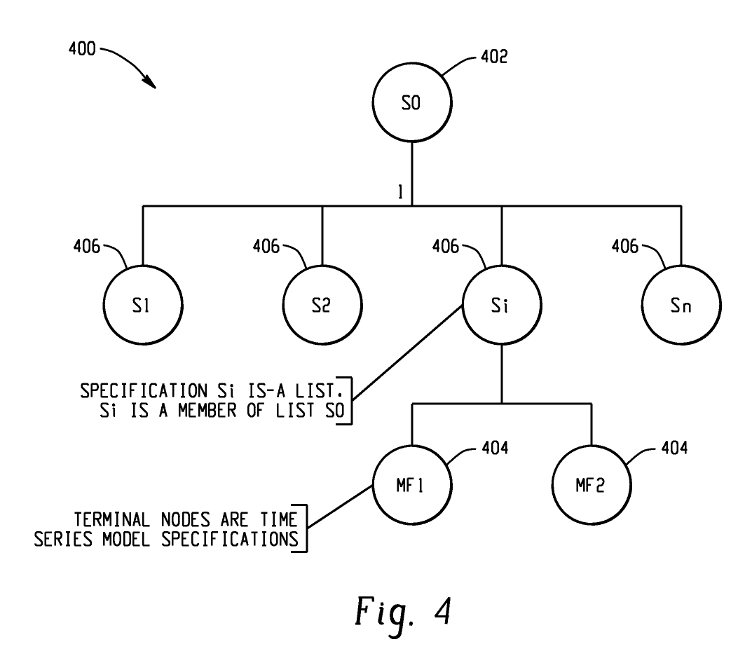

FIG. 4 depicts an example forecast model selection graph. The forecast model selection graph includes a hierarchy of nodes arranged in parent-child relationships that includes a root node 402. The forecast model selection graph also includes two model forecast nodes 404. The model forecast nodes 404 may be associated with a model that can be used to forecast one or more values for a forecast variable. A model associated with a model forecast node 404 may also be a combined model or a forecast generated outside of the combined forecast engine, such as an expert or other human generated forecast. The model forecast nodes 404 are resolved to identify a node forecast (e.g., using an associated model to generate a node forecast, accessing an expert forecast from storage).

The forecast model selection graph also includes selection nodes 406. A selection node may include a selection criteria for choosing a node forecast from among child nodes (e.g., model forecast nodes 404) of the selection node 406. Certain of the depicted selection nodes S1, S2, Sn do not have their child nodes depicted in FIG. 4.

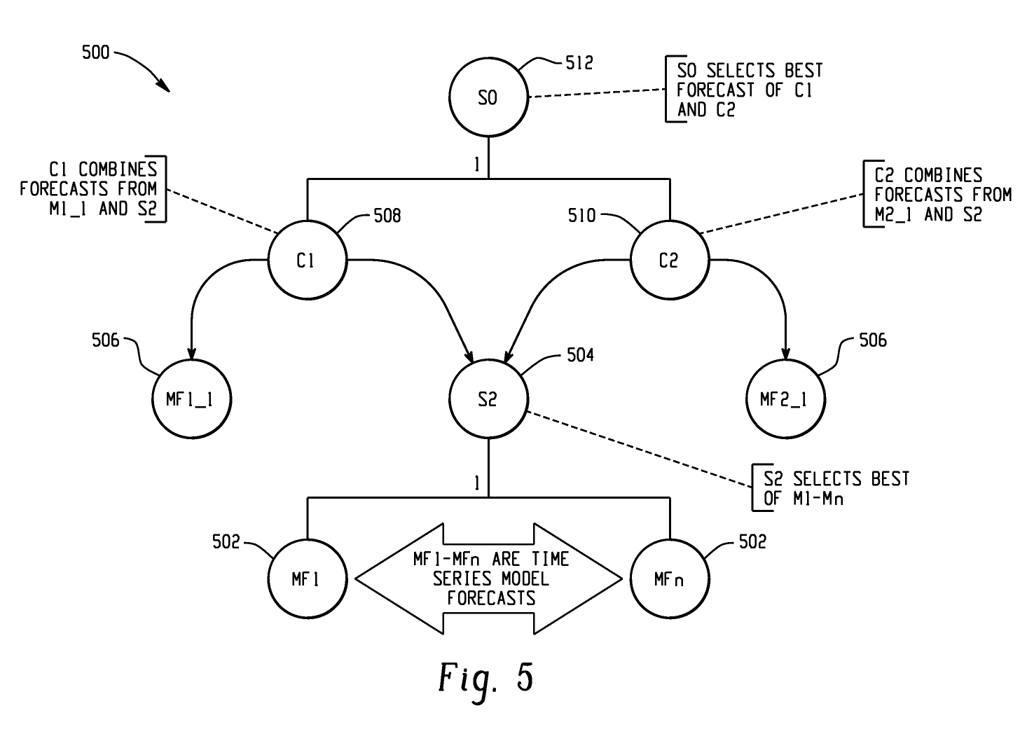

FIG. 5 depicts an example forecast model selection graph including selection nodes, combination nodes, and model forecast nodes. To generate a combined forecast for the forecast model selection graph 500, model forecast nodes 502 are resolved to generate node forecasts for one or more forecast variables (e.g., physical process attributes). With node forecasts resolved for the model forecast nodes 502, a selection node 504 selects one of the node forecasts associated with the model forecast nodes 502 based on a selection criteria. For example, the selection criteria may dictate a model forecast based on metadata associated with a model used to generate the model forecast at the model forecast node 502.

Additional model forecast nodes 506 may be resolved to generate node forecasts at those model forecast nodes 506. A first combined forecast node 508 combines a model forecast associated with model forecast node MF1_1 and the model forecast at the selection node 504 to generate a combined forecast at the combination node 508. A second combined forecast node 510 combines a model forecast associated with model forecast node MF2_1 and the model forecast at the selection node 504 to generate a combined forecast at the combination node 510. Another selection node 512 selects a model forecast from one of the two combination nodes 508, 510 based on a selection criteria as the final combined forecast for the forecast model selection graph 500.

A forecast model selection graph may take a variety of forms. For example, the forecast model selection graph may be represented in one or more records in a database or described in a file. In another implementation, the forecast model selection graph may be represented via one or more XML based data structures. The XML data structures may identify the forecast sources to combine, diagnostic tests used in the selection and filtering of forecasts, methods for determining weights to forecasts to be combined, treatment of missing values, and selection of methods for estimating forecast prediction error variance.

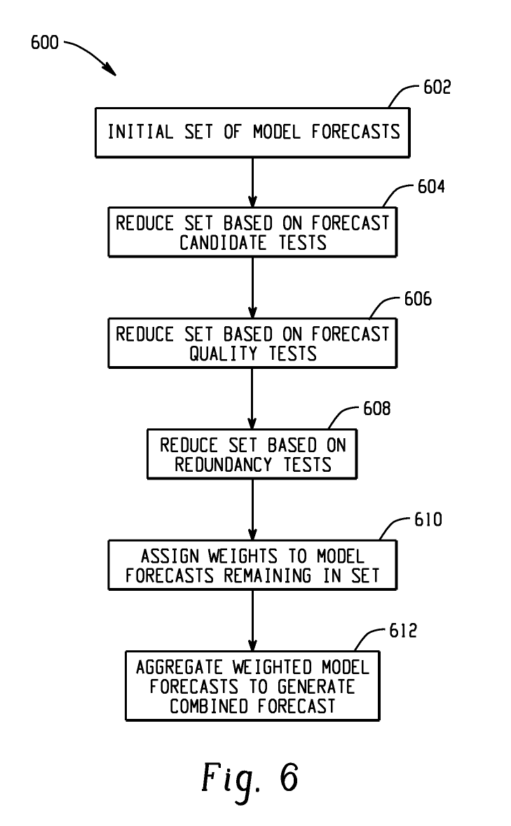

FIG. 6 is a block diagram depicting example operations that may be performed by a combined forecast engine in combining one or more forecasts (e.g., when processing a combination node). At 602, an initial set of model forecasts is identified. In some implementations, all identified model forecasts may be combined to create a combined forecast. However, in some implementations, it may be desirable to filter the models used in creating a combined forecast. For example, at 604, the set of model forecasts may be reduced at 604 based on one or more forecast candidate tests. The forecast candidate tests may take a variety of forms, such as analysis of the types of models used to generate the model forecasts identified at 602 and characteristics of the forecast variable. For example, if the forecast variable is a trending variable, the candidate tests may eliminate model forecasts generated by models that are designed to handle seasonal data.

At 606, the set of model forecasts may be reduced based on one or more forecast quality tests. Forecast quality tests may take a variety of forms. For example, forecast quality tests may analyze missing values of model forecasts. For example, model forecasts may be filtered from the set if the model forecasts have missing values in an area of interest (e.g., a forecast horizon). In another example, a model forecast may be filtered from the set if it is missing more than a particular % of values in the forecast horizon.

At 608, the set of model forecasts may be reduced based on redundancy tests. A redundancy test may analyze models associated with model forecasts nodes to identify robust models, and those models having a high degree of redundancy (e.g., models that are producing forecasts that are statistically too similar). Model forecasts having a high degree of redundancy may be excluded from the combined model being generated.

In addition to generating a combined forecast, certain statistics for a combined forecast may be determined. For example, a prediction error variance estimate may be calculated. The prediction error variance estimate may incorporate pair-wise correlation estimates between the individual forecast prediction errors for the predictions that make up the combined forecast and their associated prediction error variances.

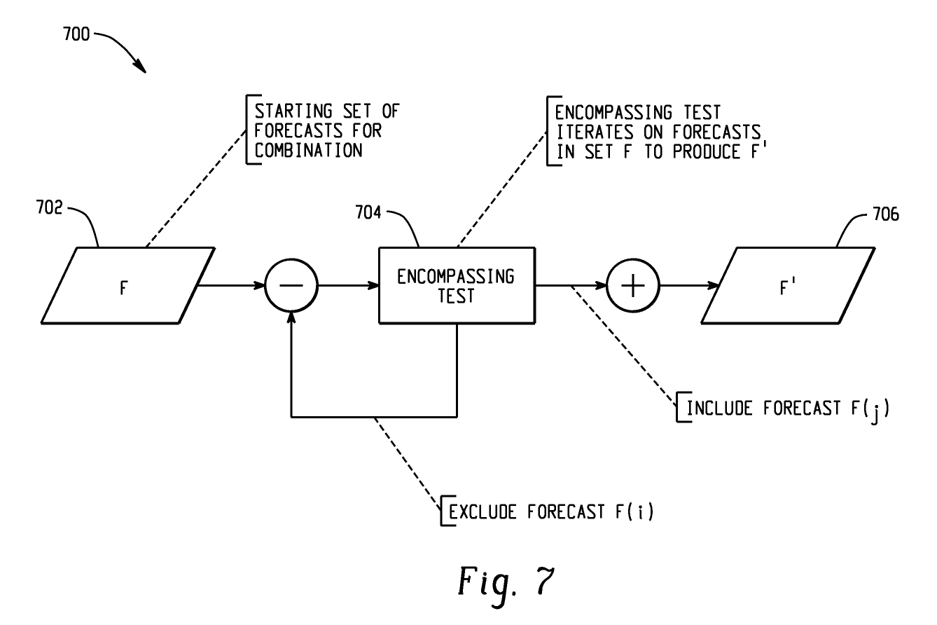

FIG. 7 is a flow diagram depicting an example redundancy test in the form of an encompassing test. The set of model forecasts is shown at 702. At 704, each model in the set 702 is analyzed to determine whether the current model forecast is redundant (e.g., whether the information in the current model forecast is already represented in the continuing set of forecasts 706). If the current model forecast is redundant, then it is excluded. If the current model forecast is not redundant, then it remains in the set of forecasts 706.

With reference back to FIG. 6, at 610, weights are assigned to the model forecasts remaining in the set. Weights may be assigned using a number of different algorithms. For example, weights may be assigned as a straight average of the set of remaining model forecasts, or more complex processes may be implemented, such as a least absolute deviation procedure. At 612, the weighted model forecasts are aggregated to generate a combined forecast.

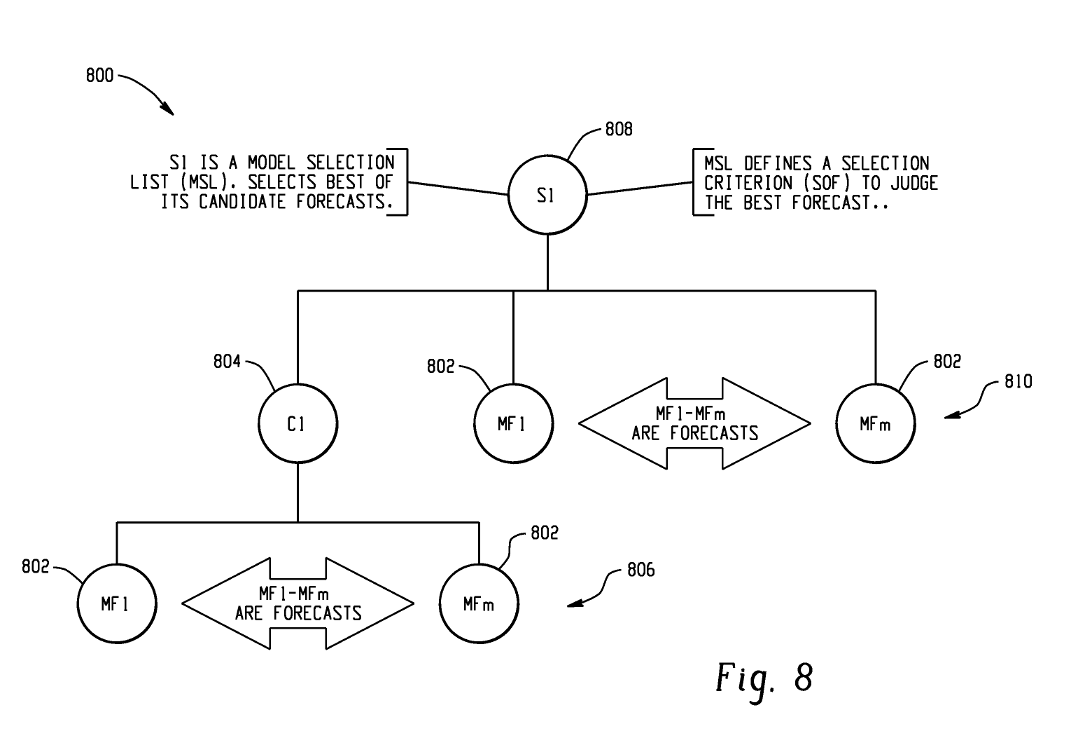

FIG. 8 depicts a forecast model selection graph having a selection node as a root node. A number of node forecasts 802 are resolved (e.g., by generating node forecasts using a model, accessing externally generated forecasts from computer memory). A combination node 804 combines the model forecasts of child nodes 806 of the combination node 804. A selection node 808 selects a forecast from among the combination node 804 and model forecasts at child nodes 810 of the selection node 808 based on a selection criteria.

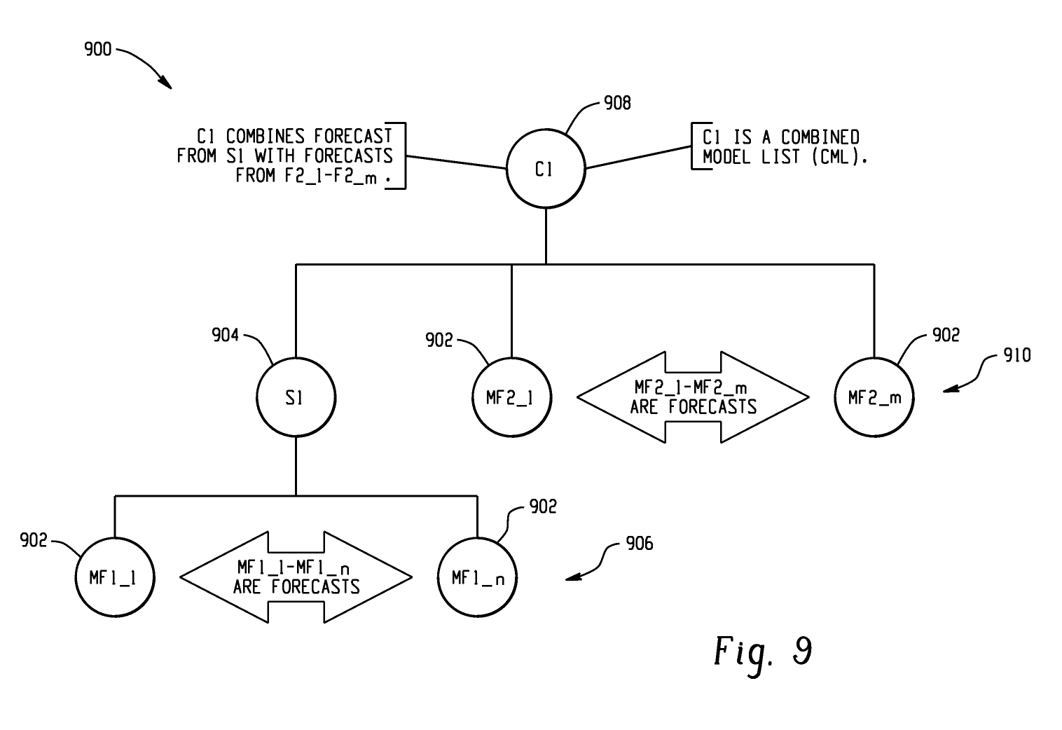

FIG. 9 depicts a forecast model selection graph having a combination node as a root node. A number of node forecasts 902 are resolved (e.g., by generating node forecasts using a model, accessing externally generated forecasts from memory). A selection node 904 selects a model forecast from the child nodes 906 of the selection node. A combination node 908 combines the model forecast from the selection node 904 and model forecasts at child nodes 910 of the combination node 908 to generate a combined forecast.

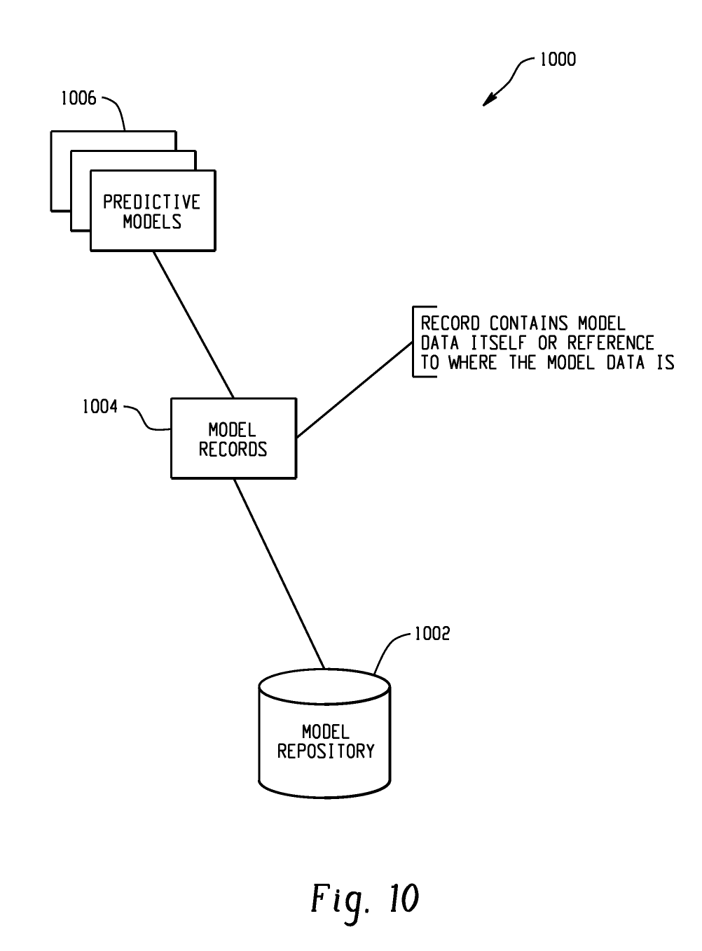

As noted previously, a model forecast node may be associated with a predictive model that is used to generate a model forecast for the model forecast node. In one embodiment, the predictive models may be stored in a model repository for convenient access. FIG. 10 depicts an example model repository for storing predictive models. The model repository 1002 includes a number of model records 1004. A model record may contain model data for implementing a predictive model 1006. In another embodiment, a model record 1004 may contain a reference to where data for implementing the predictive model 1006 can be found (e.g., a file location, a pointer to a memory location, a reference to a record in a database). Other example details of a model repository are described in U.S. Pat. No. 7,809,729, entitled “Model Repository,” the entirety of which is herein incorporated by reference.

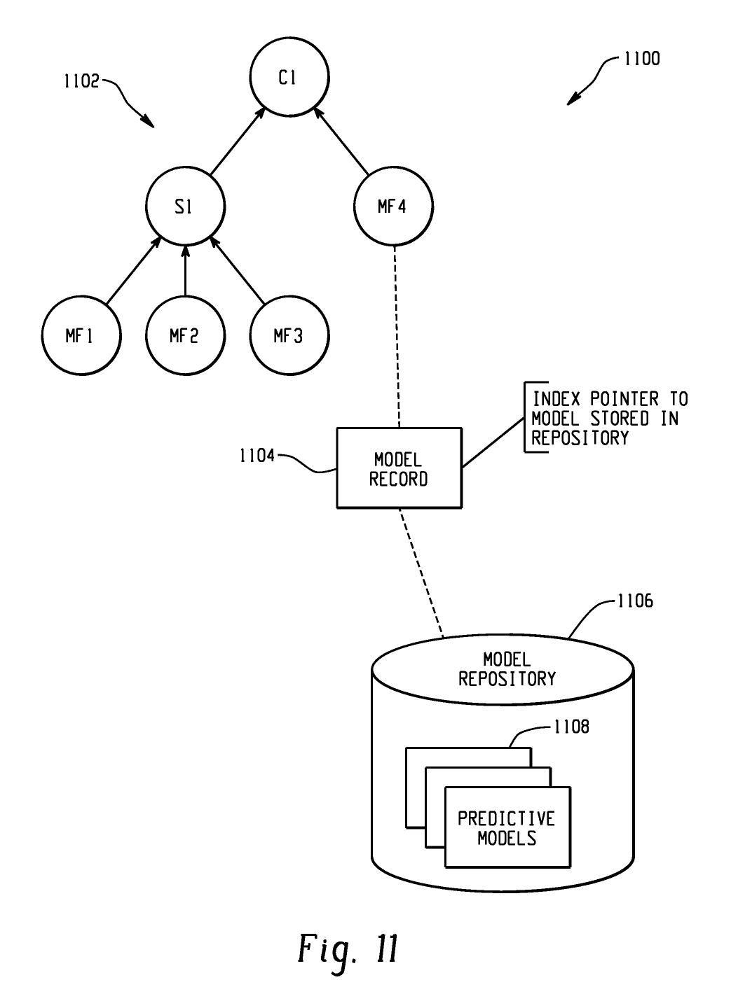

A model repository configuration may streamline the data contained in a forecast model selection graph. FIG. 11 depicts a link between a forecast model selection graph and a model repository. A forecast model selection graph 1102 includes a number of model forecast nodes MF1, MF2, MF3, MF4, a selection node S1, and a combination node C1. The model forecast nodes are resolved to generate node forecasts. One of the model forecast nodes, MF4, is associated with a model record 1104. For example, model forecast node, MF4, may contain an index value for the model record 1104. The model record is stored in the model repository 1104 and may contain data for implementing a predictive model to generate the node forecast, or the model record may contain a reference to the location of such data 1108, such as a location in a the model repository 1106. When the model forecast node, MF4, is to be resolved, the model record 1104 is located based on the index identified by the model forecast node, MF4. Data for the desired predictive model 1108 to be used to generate the node forecast is located in the model repository 1106 based on data contained in the model record 1104.

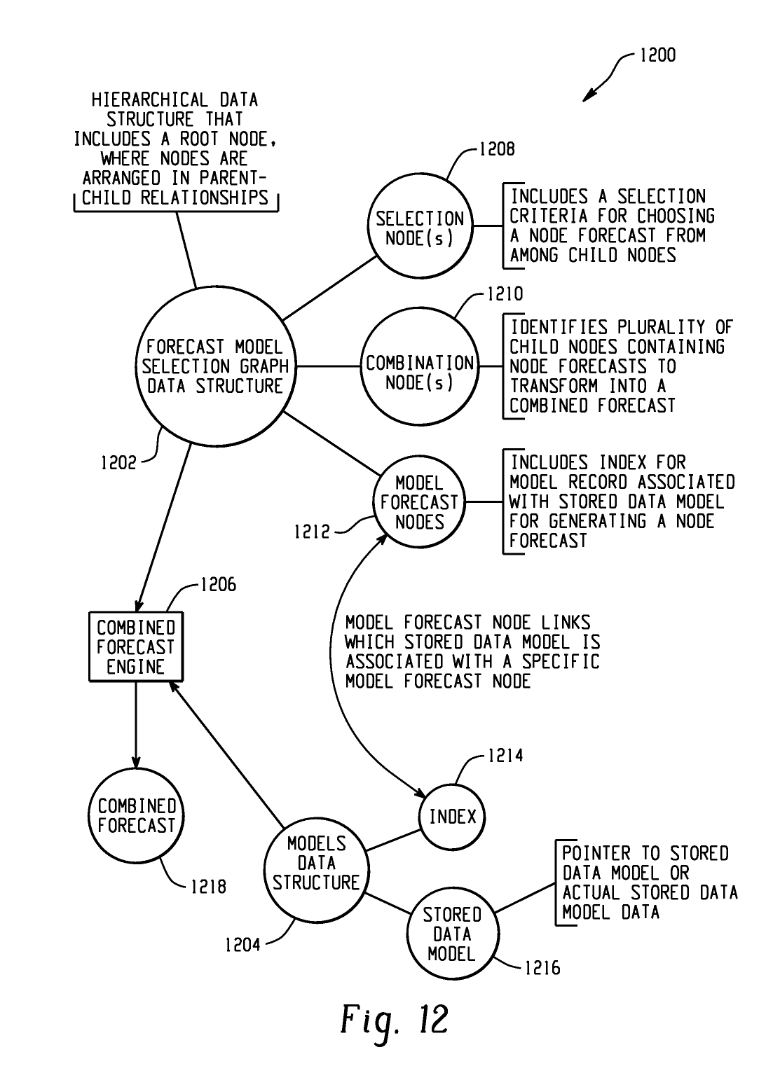

FIG. 12 is a diagram depicting relationships among a forecast model selection graph data structure, a models data structure, and a combined forecast engine. A forecast model selection graph data structure 1202 and a models data structure 1204 may be stored on one or more computer-readable storage mediums for access by an application program, such as a combined forecast engine 1206 being executed on one or more data structures. The data structures 1202, 1204 may be used as part of a process for evaluating a physical process with respect to one or more attributes of the physical process by combining forecasts for the one or more physical process attributes. Physical process data generated over time (e.g., time series data) may be used in the forecasts for the one or more physical attributes.

The forecast model selection graph data structure 1202 may contain data about a hierarchical structure of nodes which specify how forecasts for the one or more physical attributes are combined, where the hierarchical structure of nodes has a root node, and where the nodes include one or more selection nodes 1208, one or more model combination nodes 1210, and model forecast nodes 1212. The forecast model selection graph data structure 1202 may include selection node data 1208 that specifies, for the one or more model selection nodes, model selection criteria for selecting, based upon model forecasting performance, models associated with the model forecast nodes or the one or more model combination nodes. The forecast model selection graph data structure 1202 may also include model combination node data 1210 that specifies, for the one or more model combination nodes, which of the forecasts generated by the model forecast nodes are to be combined.

The forecast model selection graph data structure 1202 may also include model forecast node data 1212 that specifies, for the model forecast nodes, which particular predictive data models contained in the models data structure are to be used for generating forecasts. For example, the model forecast node data 1212 may link which stored data model is associated with a specific model forecast node, such as via an index 1214. The stored data model 1216 identified by the model forecast node data 1212 may be accessed as part of a resolving process to generate a node forecast for a particular node of the model forecast selection graph. The combined forecast engine 1206 may process the forecast model selection graph data structure 1202, using stored data models 1216 identified by the models data structure 1204 via the link between the model forecast node data 1212 and the models data structure 1204 to generate a combined forecast 1218.

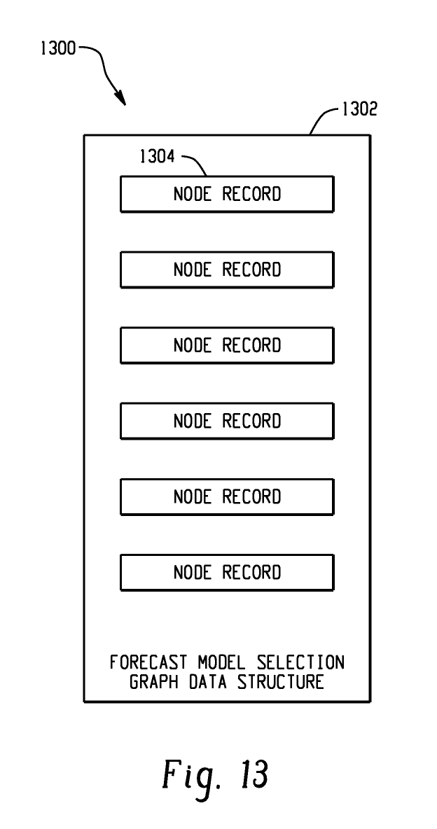

FIG. 13 depicts an example forecast model selection graph data structure. In FIG. 13, the forecast model selection graph data structure 1302 is a data structure that includes a number of node records 1304 as sub-data structures. The node records 1304 may each be descriptive of a model forecast node, a combination node, or a selection node. Each of the node records 1304 includes data.

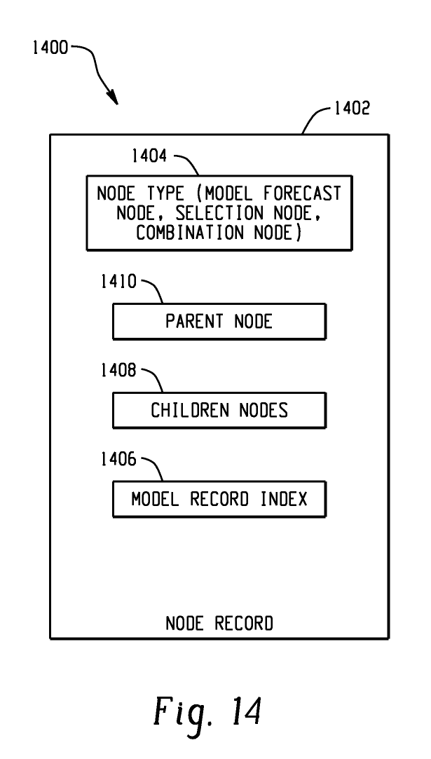

FIG. 14 depicts an example node record. For example, the node record 1402 may contain data related to the type of a node 1404 and data for the node to be processed, such as an identification of a model to generate a node forecast 1406 or a selection criteria for selecting among child nodes. Additionally, a node record 1402 may include structure data that identifies, in whole or in part, a position of a node in the forecast model selection graph. For example, the node record data may contain data identifying child nodes 1408 of a node and a parent node 1410 of the node. The node record 1402 may also identify a node as a root or a leaf node or the exact position of a node in the forecast model selection graph hierarchy (e.g., a pre-order or a post-order value).

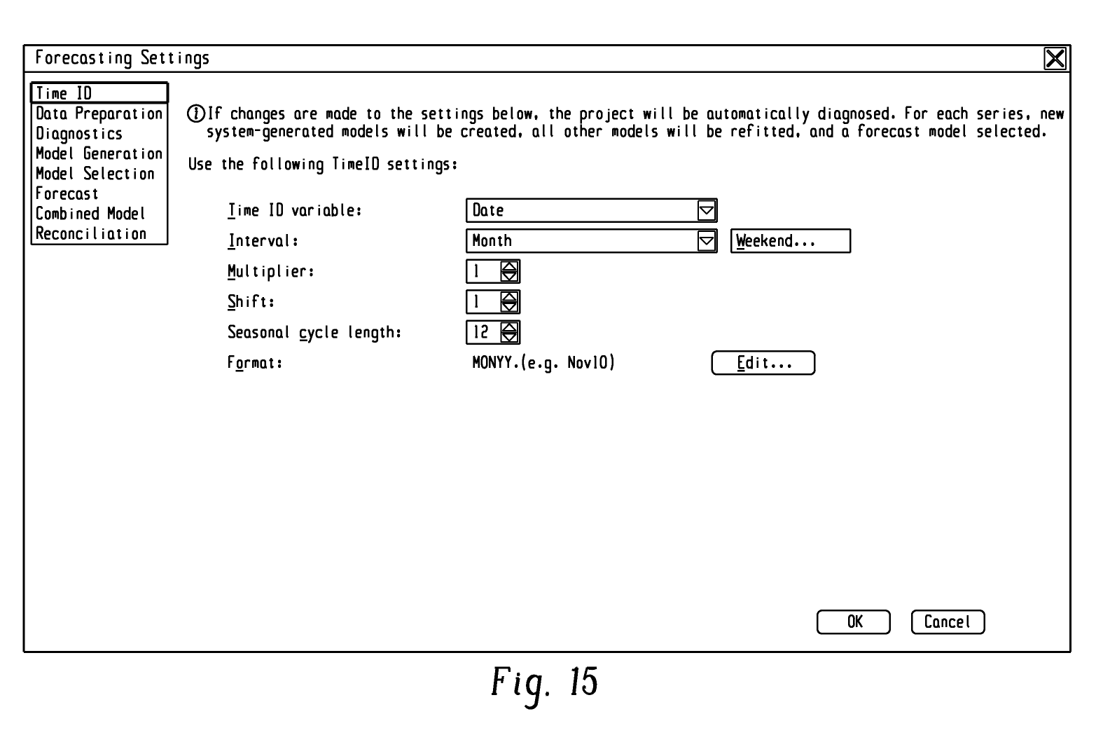

FIGS. 15-32 depict graphical user interfaces that may be used in generating and comparing combined forecasts. FIG. 15 depicts an example graphical user interface for identifying parameters related to time, where a user may specify parameters such as a time interval, a multiplier value, a shift value, a seasonal cycle length, and a date format.

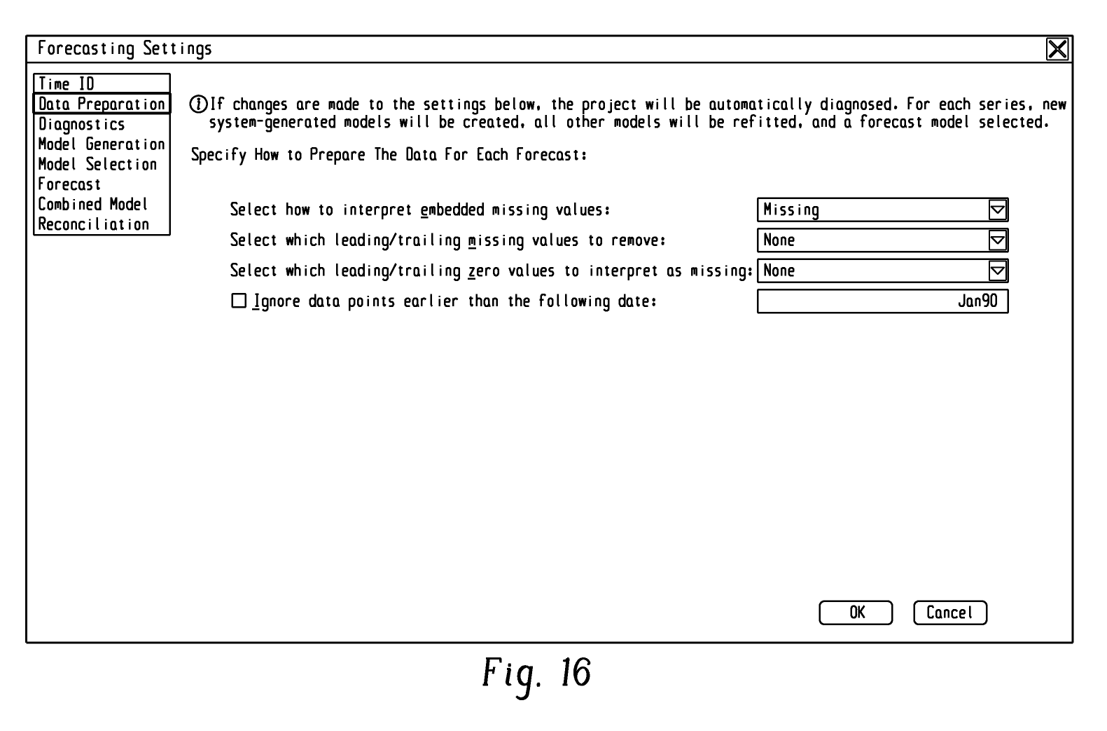

FIG. 16 depicts an example forecasting settings graphical user interface for identifying parameters related to data preparation, where a user may specify how to prepare data for forecasting. Example settings include how to interpret embedded missing values, which leading or trailing missing values to remove, which leading or trailing zero values to interpret as missing, and whether to ignore data points earlier than a specified date.

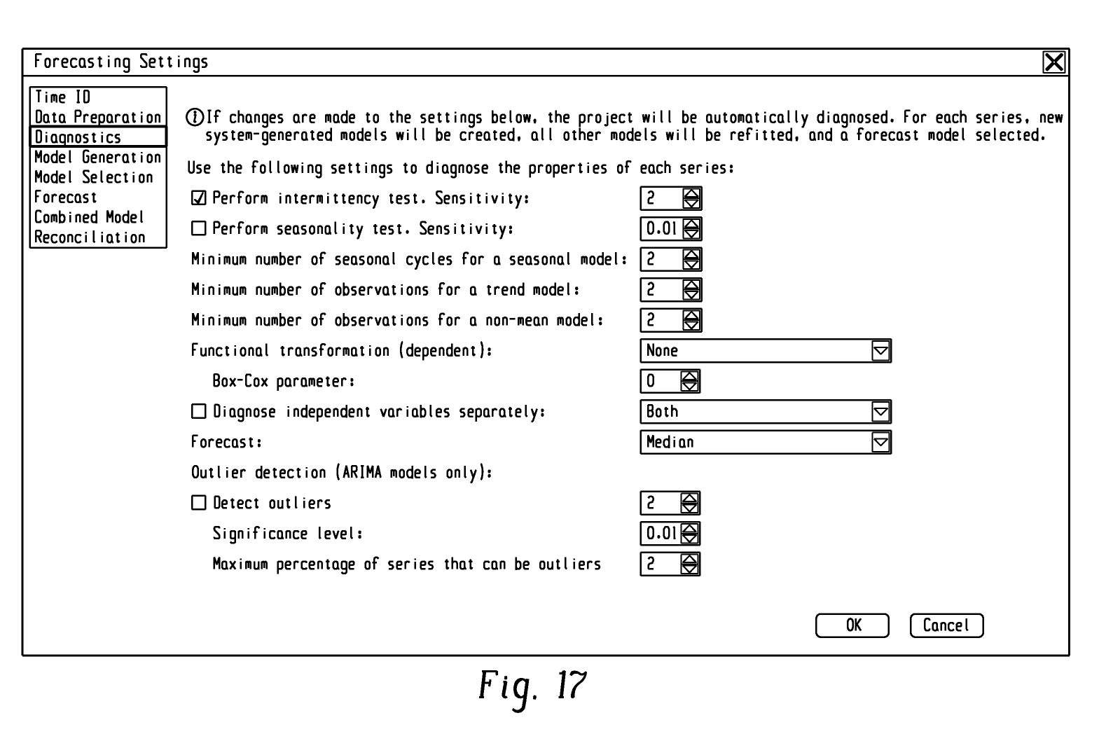

FIG. 17 depicts an example forecasting settings graphical user interface for identifying diagnostics settings. Example settings include intermittency test settings, seasonality test settings, independent variable diagnostic settings, and outlier detection settings. Such diagnostic settings may be used in a variety of contexts, including processing of combination nodes of a forecast model selection graph.

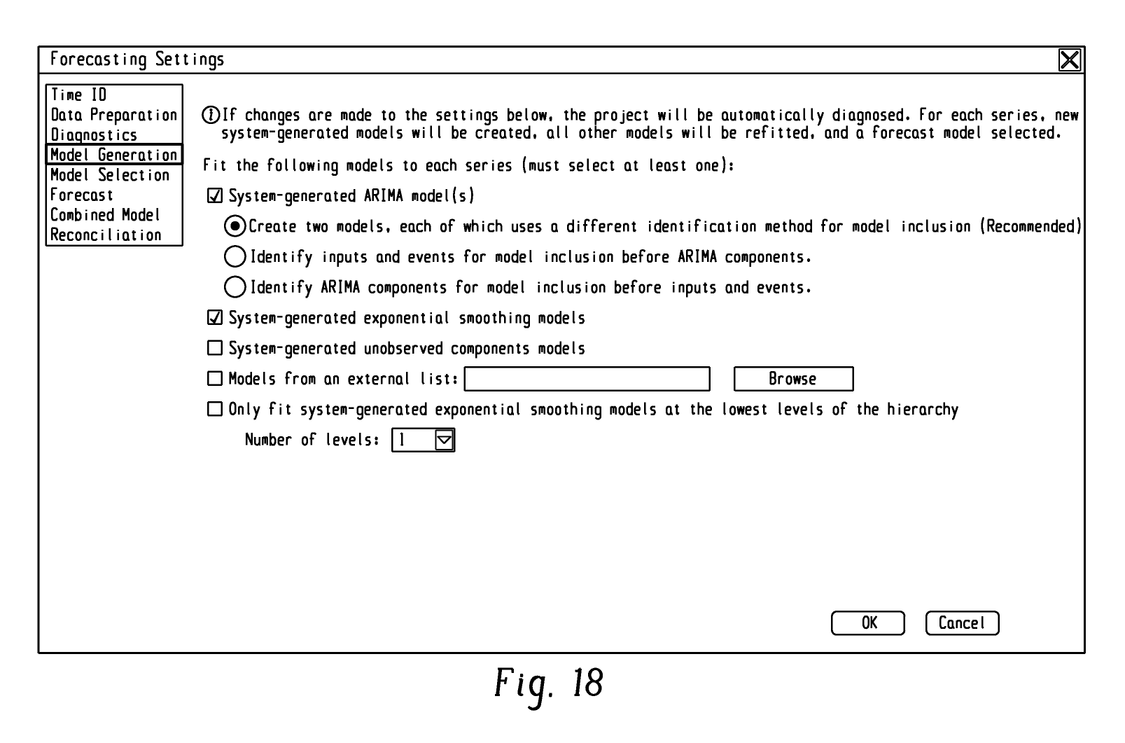

FIG. 18 depicts an example forecasting settings graphical user interface for identifying model generation settings. Example settings include identifications of which models to fit to each time series. Example models include system-generated ARIMA models, system-generated exponential smoothing models, system-generated unobserved components models, and models from an external list. Such model generation settings may be used in a variety of contexts, including with model forecast nodes of a forecast model selection graph.

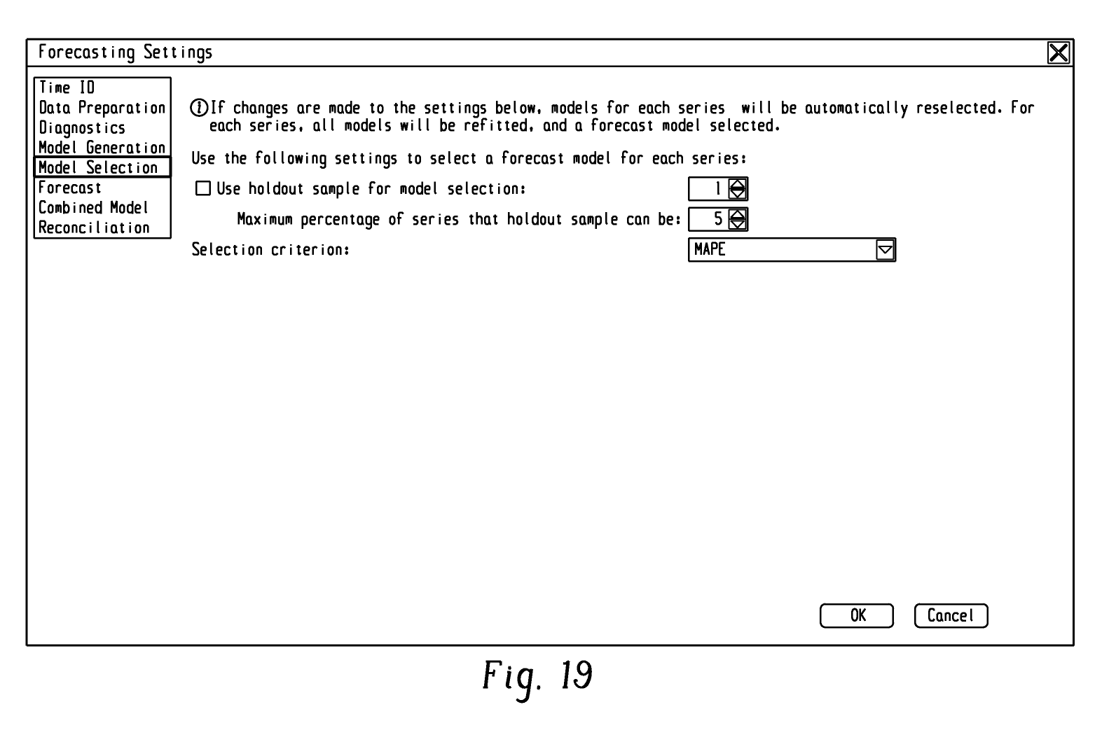

FIG. 19 depicts an example forecasting settings graphical user interface for identifying model selection settings. Example settings include whether to use a holdout sample in performing model selection and a selection criteria for selecting a forecast. Such model selection settings may be used in a variety of contexts, including with model selection nodes of a forecast model selection graph.

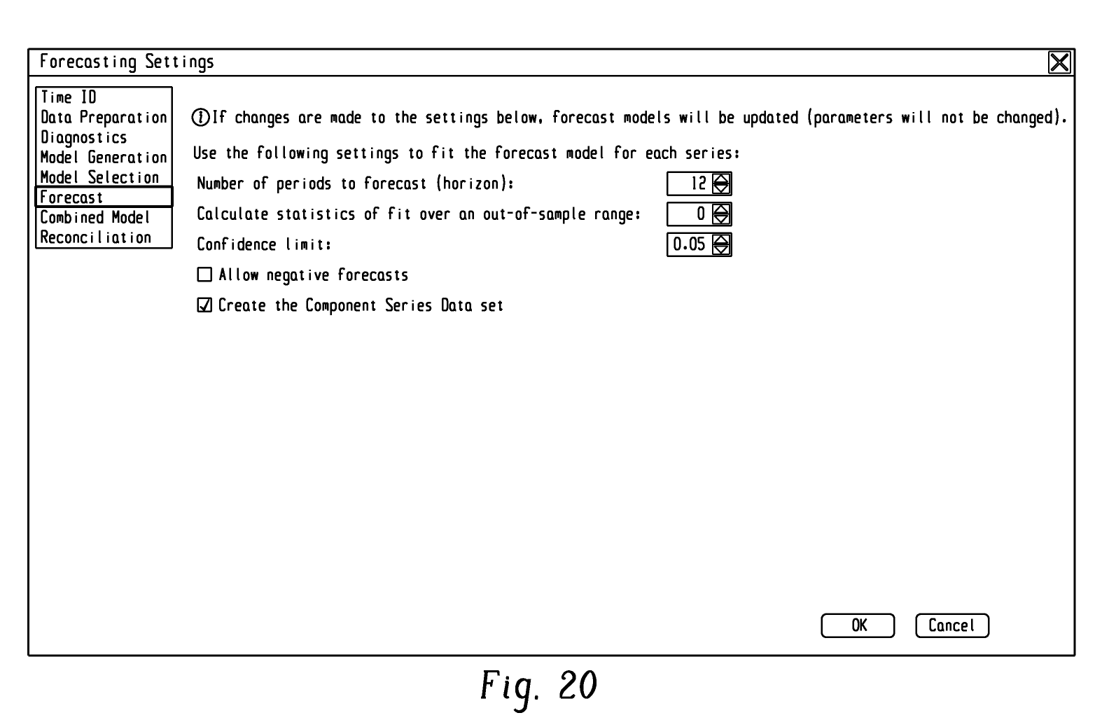

FIG. 20 depicts an example forecasting settings graphical user interface for identifying model forecast settings. Example settings include a forecast horizon, calculation of statistics of fit settings, confidence limit settings, negative forecast settings, and component series data set settings.

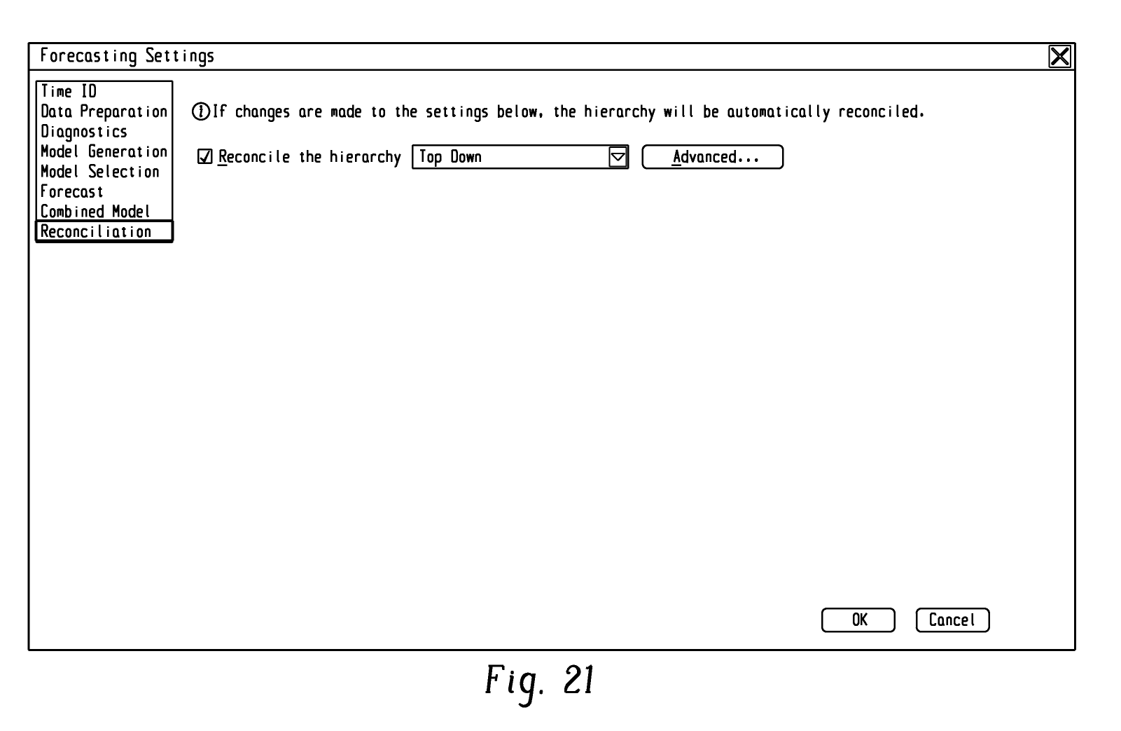

FIG. 21 depicts an example forecasting settings graphical user interface for identification of hierarchical forecast reconciliation settings. Using the user interface of FIG. 21, a preference for reconciliation of a forecast hierarchy may be selected along with a method for performing the reconciliation, such as a top-down, bottom-up, or middle-out process.

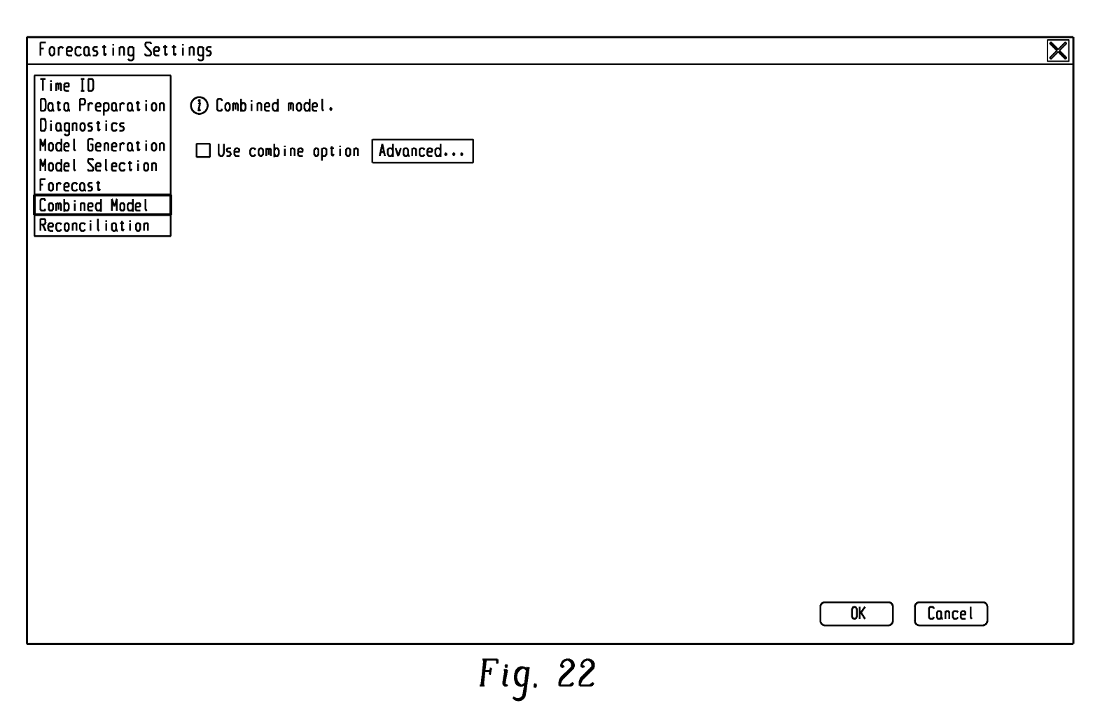

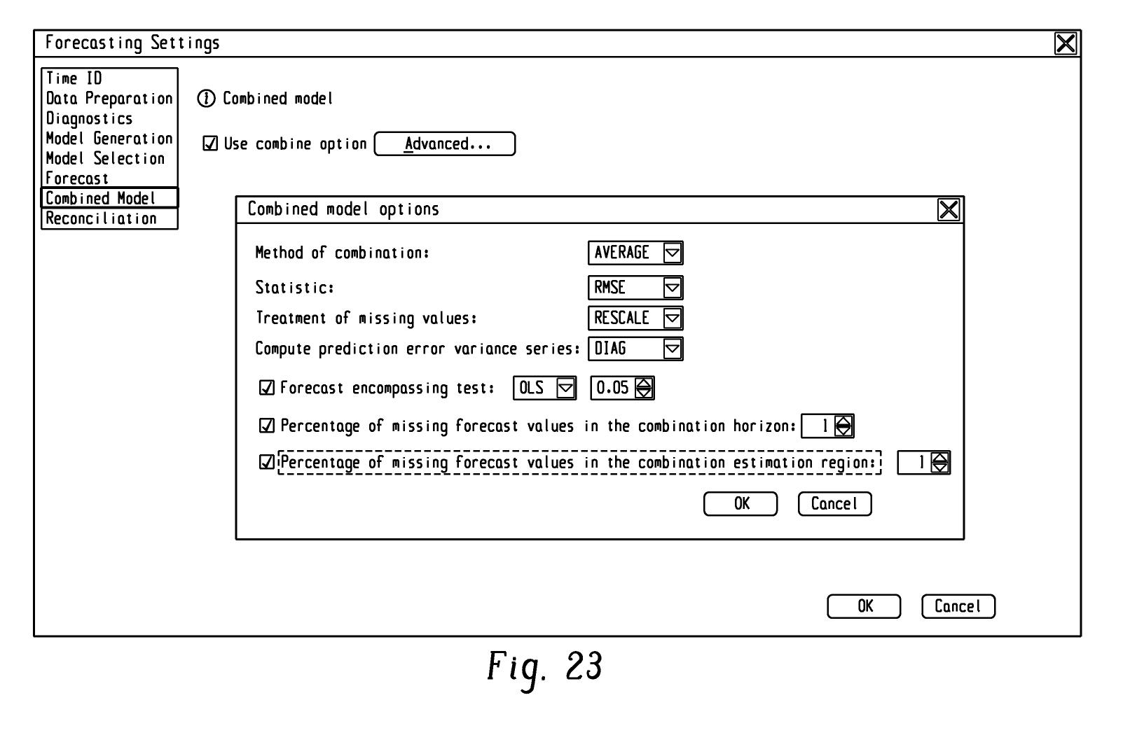

FIG. 22 depicts an example forecasting settings graphical user interface for combined model settings. The combined model settings user interface allows selection of a combine model option. The user interface of FIG. 22 also includes an advanced options control. FIG. 23 depicts an example graphical user interface for specification of advanced combined model settings. The settings of FIG. 23 may be used in a variety of contexts, including in processing of a combination node of a forecast model selection graph.

Example settings for advanced combined model settings include a method of combination setting. Example parameters include a RANKWGT setting, where a combined forecast engine analyzes the forecasts to be combined and assigns weights to those forecasts based on the analysis. In another example, the RANKWGT option may accept a set of user-defined weights that are substituted for the automatic rank weight settings for each ordinal position in the ranked set. The combined forecast engine analyzes and ranks the forecasts to be combined and then assigns the user-defined weights to the forecasts according to the forecast's ordinal position in the ranking. As another option, a user may directly assign weights to the individual forecasts, and as a further option, a mean-average of the individual forecasts may be utilized.

The advanced settings interface also includes an option for directing that a forecast encompassing test be performed. When selected, the combined forecast engine ranks individual forecasts for pairwise encompassing elimination. The advanced setting interface further includes options related to treatment of missing values. For example, a rescale option may be selected for weight methods that incorporate a sum-to-one restriction for combination weights. A further option directs a method of computation of prediction error variance series. This option is an allowance for treating scenarios where the cross-correlation between two forecast error series is localized over segments of time when it is assumed that the error series are not jointly stationary. DIAG may be the default setting, while ESTCORR presumes that the combination forecast error series are jointly stationary and estimates the pairwise cross-correlations over the complete time spans.

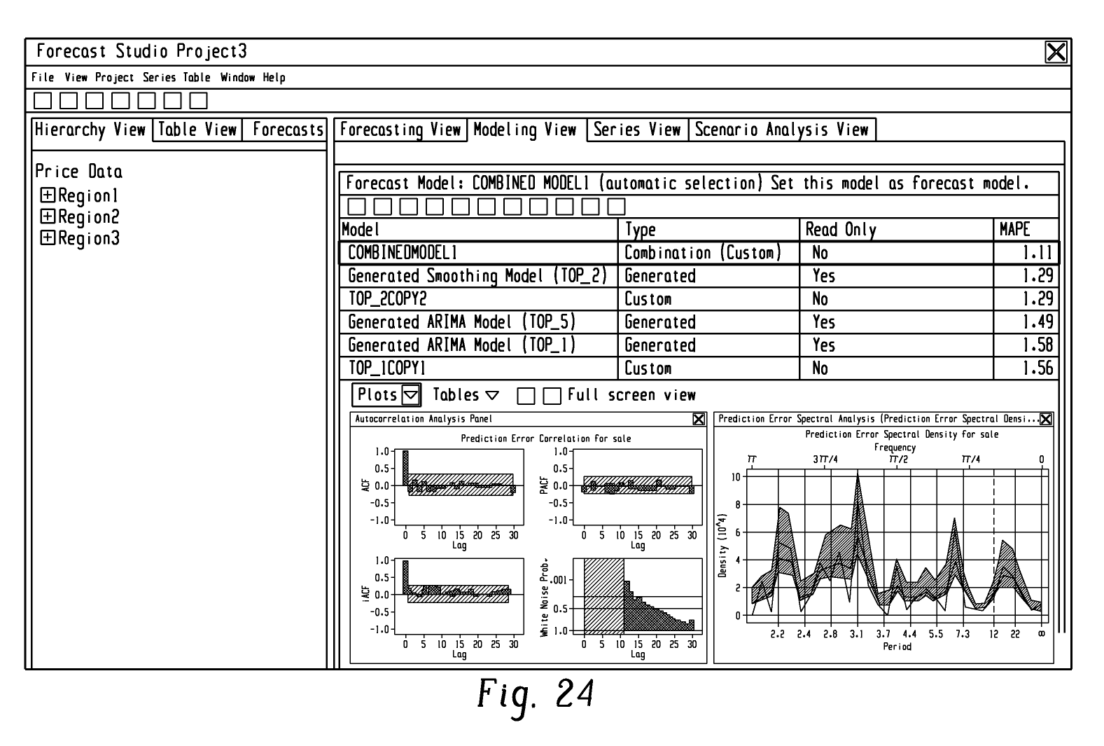

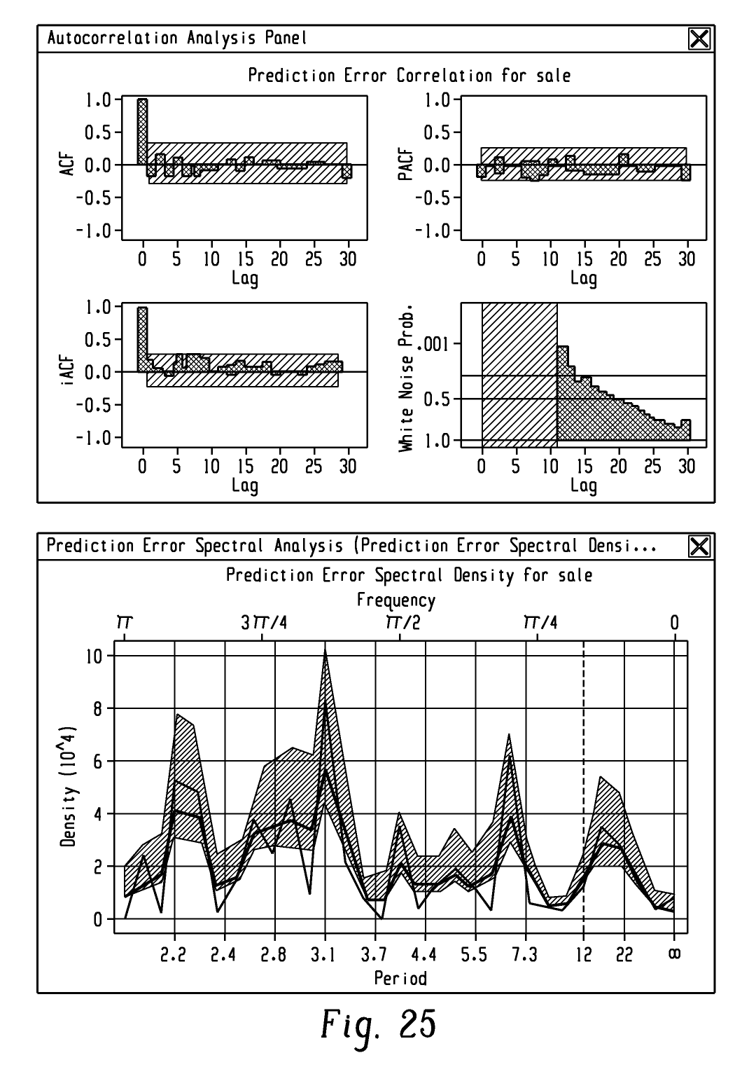

FIG. 24 depicts a model view graphical user interface. Using the model view, a user can evaluate combined model residuals. The user interface is configured to enable graphical analysis of a model residual series plot, residual distribution, time domain analysis (e.g., ACF, PACF, IACF, white noise), frequency domain analysis (e.g., spectral density, periodogram). The user interface also enables exploration of parameter estimates, statistics of fit (e.g., RMSE, MAPE, AIC), and bias statistics. FIG. 25 depicts example graphs that may be provided by a model view graphical interface. Other options provided by a model view graphical user interface may include options for managing model combinations, such as adding a model for consideration, editing a previously added model, copying a model, and deleting a model (e.g., a previously added combined model).

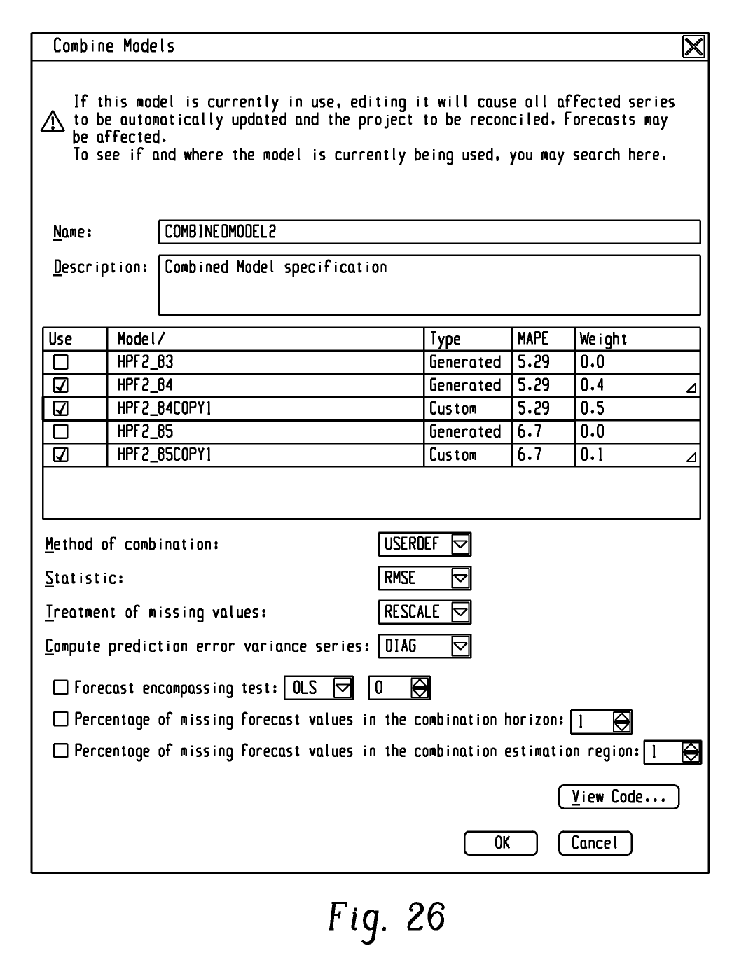

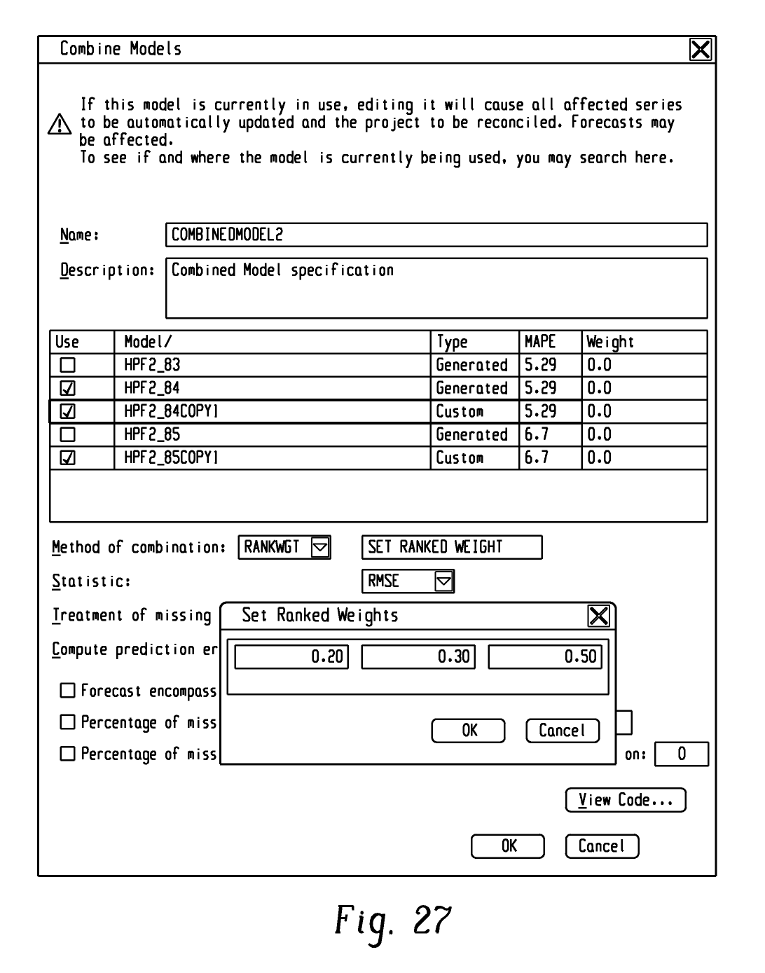

FIG. 26 depicts an example graphical user interface for manually defining a combined model. For example, a manually defined combined model may be utilized with a model forecast node in a forecast model selection graph. The graphical user interface may be configured to receive a selection of one or more models to be combined, weights to be applied to those combined models in generating the combination, as well as other parameters. For example, FIG. 27 depicts the manual entry of ranked weights to be applied to the selected models after they are ranked by a combined forecast engine.

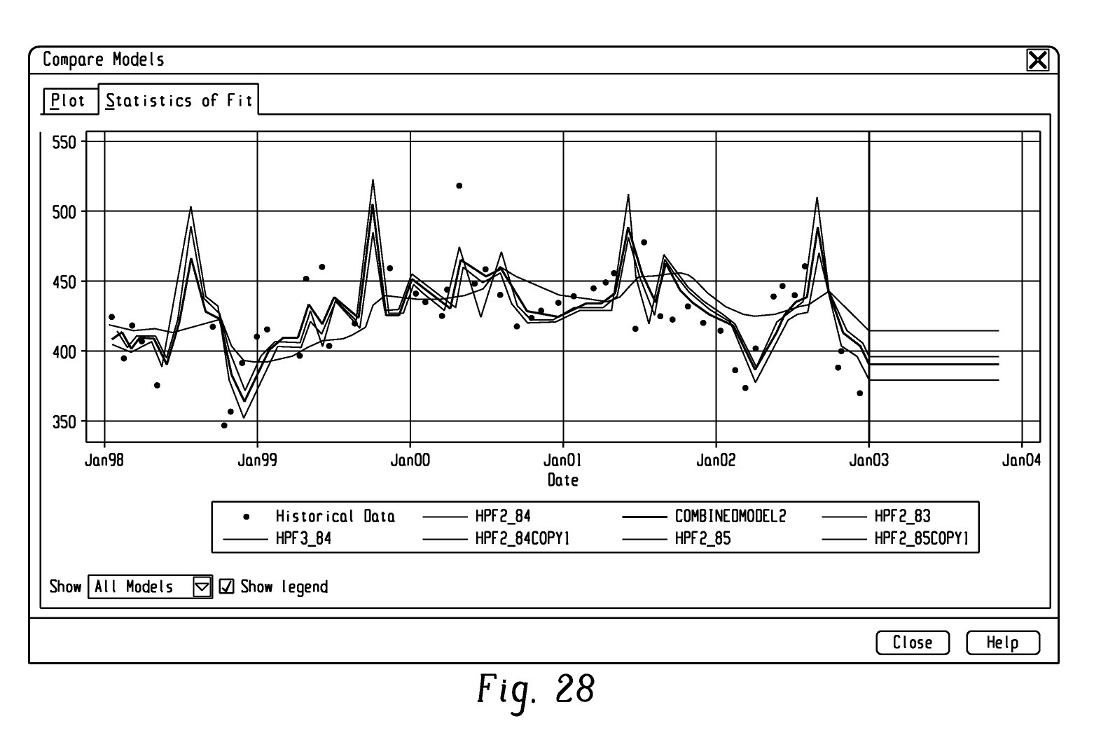

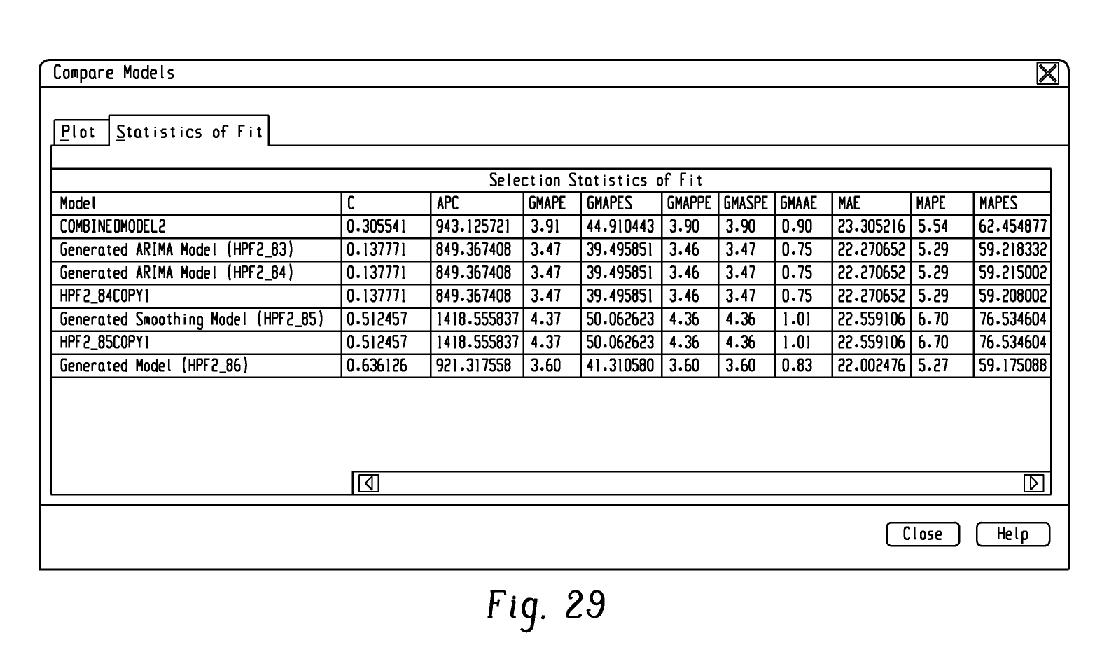

FIG. 28 depicts an example interface for comparing models. The example interface may be accessed via a model view interface. The present interface enables comparison of selected model combinations in graphical form. FIG. 29 depicts a table that enables comparison of selected model combinations statistically in text form.

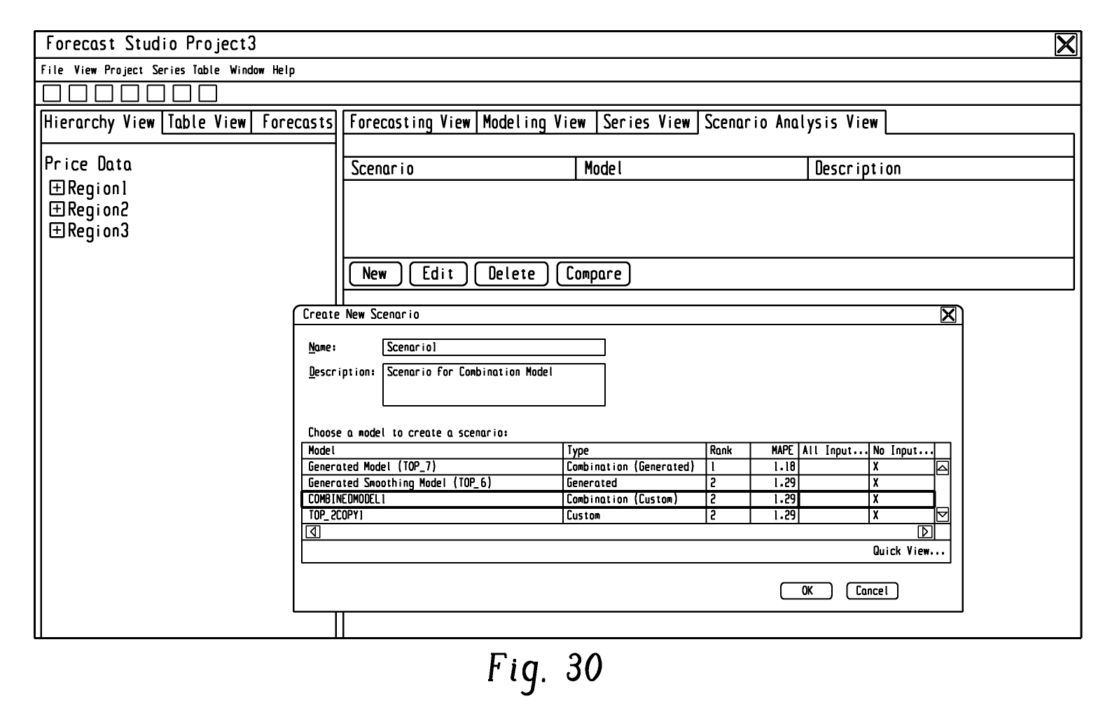

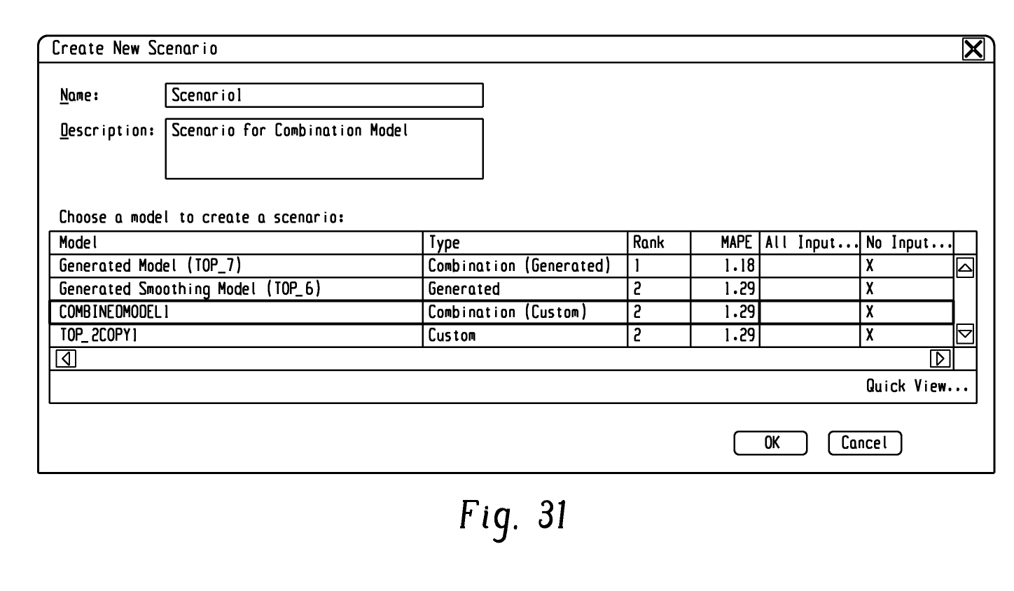

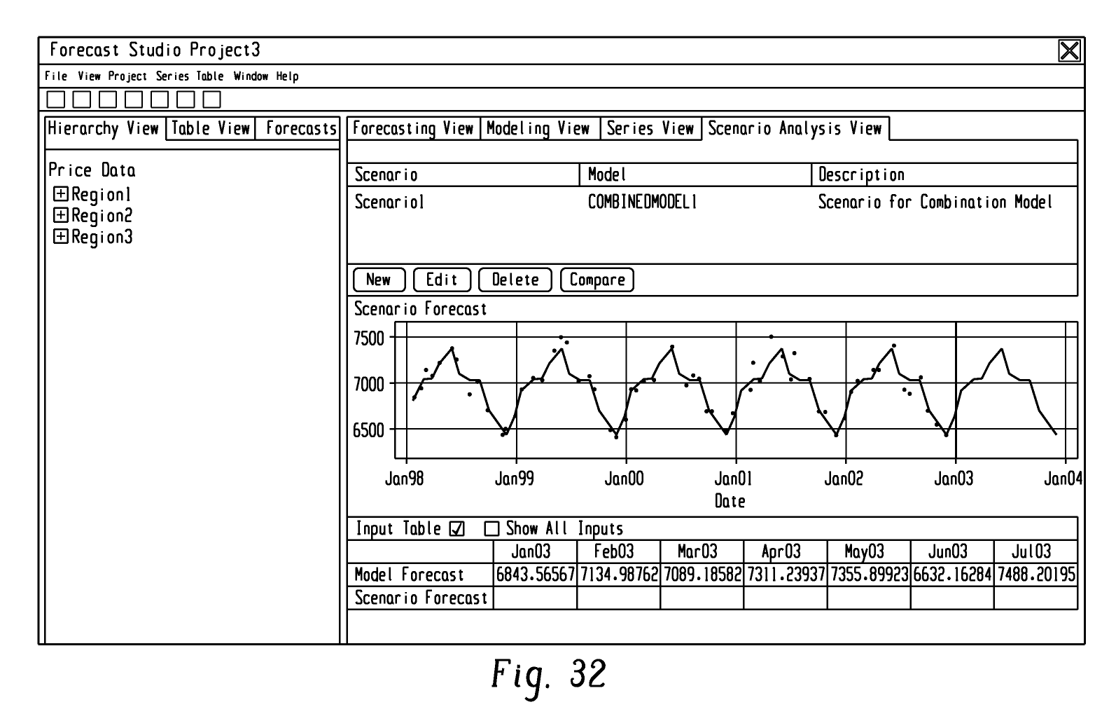

FIG. 30 depicts a graphical user interface for performing scenario analysis using model combinations. Using scenario analysis, scenarios can be generated, where an input time series can be varied to better understand possible future outcomes and to evaluate a model's sufficiency to different input values. A create new scenario menu may be accessed by selecting a new control in a scenario analysis view. Using the create new scenario menu, shown in further detail in FIG. 31, a model is selected for analysis. A scenario is generated, and a graph depicting results of the scenario analysis is displayed, such as the graph of FIG. 32.

The systems and methods described herein may, in some implementations, be utilized to achieve one or more of the following benefits. For example, forecast accuracy may often be significantly improved by combining forecasts of individual predictive models. Combined forecasts also tend to produce reduced variability compared to the individual forecasts that are components of a combined forecast. The disclosed combination process may automatically generate forecast combinations and vet them against other model and expert forecasts as directed by the forecast model selection graph processing. Combined forecasts allow for better predicting systematic behavior of an underlying data generating process that cannot be captured by a single model forecast alone. Frequently, combinations of forecasts from simple models outperform a forecast from a single, complex model.

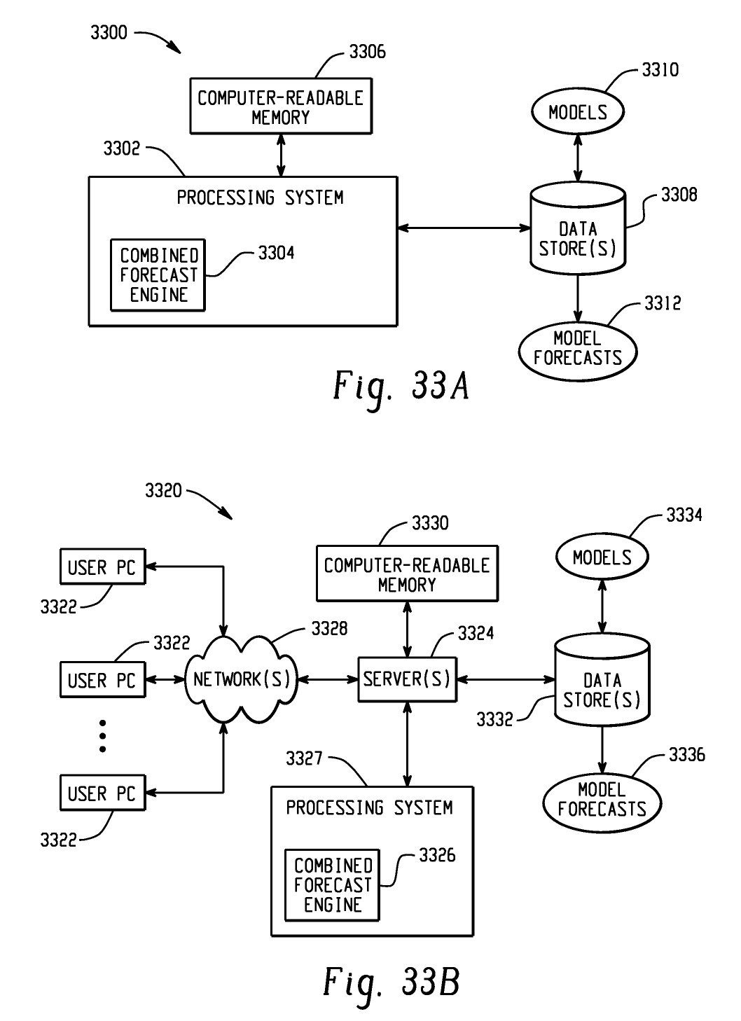

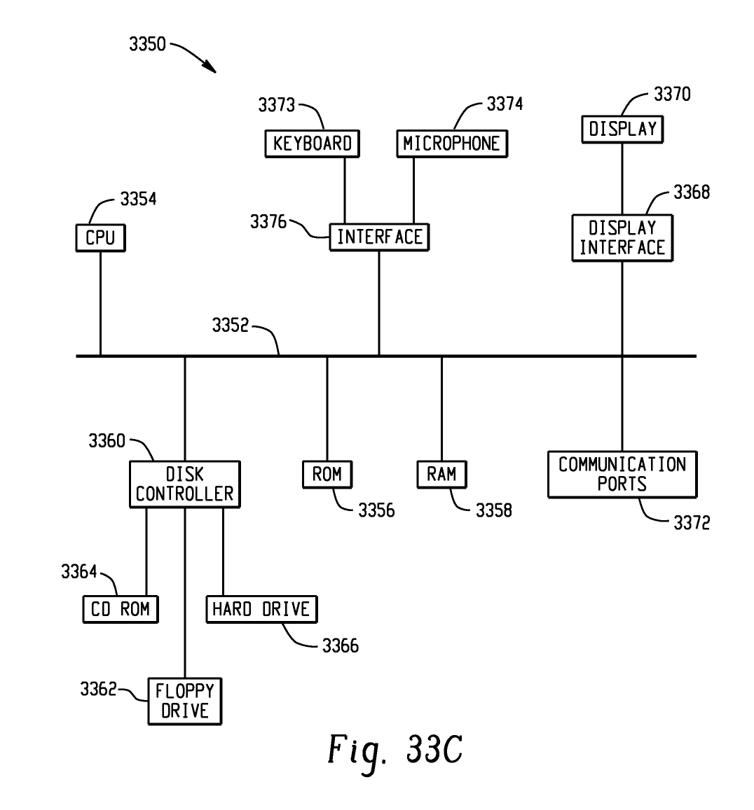

FIGS. 33A, 33B, and 33C depict example systems for use in implementing an enterprise data management system. For example, FIG. 33A depicts an exemplary system 3300 that includes a standalone computer architecture where a processing system 3302 (e.g., one or more computer processors) includes a combined forecast engine 3304 being executed on it. The processing system 3302 has access to a computer-readable memory 3306 in addition to one or more data stores 3308. The one or more data stores 3308 may include models 3310 as well as model forecasts 3312.

FIG. 33B depicts a system 3320 that includes a client server architecture. One or more user PCs 3322 accesses one or more servers 3324 running a combined forecast engine 3326 on a processing system 3327 via one or more networks 3328. The one or more servers 3324 may access a computer readable memory 3330 as well as one or more data stores 3332. The one or more data stores 3332 may contain models 3334 as well as model forecasts 3336.

FIG. 33C shows a block diagram of exemplary hardware for a standalone computer architecture 3350, such as the architecture depicted in FIG. 33A that may be used to contain and/or implement the program instructions of system embodiments of the present invention. A bus 3352 may serve as the information highway interconnecting the other illustrated components of the hardware. A processing system 3354 labeled CPU (central processing unit) (e.g., one or more computer processors), may perform calculations and logic operations required to execute a program. A processor-readable storage medium, such as read only memory (ROM) 3356 and random access memory (RAM) 3358, may be in communication with the processing system 3354 and may contain one or more programming instructions for performing the method of implementing a combined forecast engine. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 3360 interfaces one or more optional disk drives to the system bus 3352. These disk drives may be external or internal floppy disk drives such as 3362, external or internal CD-ROM, CD-R, CD-RW or DVD drives such as 3364, or external or internal hard drives 3366. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 3360, the ROM 3356 and/or the RAM 3358. Preferably, the processor 3354 may access each component as required.

A display interface 3368 may permit information from the bus 3352 to be displayed on a display 3370 in audio, graphic, or alphanumeric format. Communication with external devices may optionally occur using various communication ports 3372.

In addition to the standard computer-type components, the hardware may also include data input devices, such as a keyboard 3373, or other input device 3374, such as a microphone, remote control, pointer, mouse and/or joystick.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of evaluating a physical process with respect to one or more attributes of the physical process by combining forecasts for the one or more physical process attributes, where data for evaluating the physical process is generated over time, the method comprising:
accessing a forecast model selection graph, the forecast model selection graph comprising a hierarchy of nodes arranged in parent-child relationships including a root node, the nodes including a selection node, a combination node, and a plurality of model forecast nodes;
resolving the plurality of model forecast nodes, resolving a model forecast node including generating a node forecast for the one or more physical process attributes;
processing a combination node, a combination node transforming a plurality of node forecasts at child nodes of the combination node into a combined forecast;
processing a selection node, a selection node choosing a node forecast from among child nodes of the selection node based on a selection criteria; and
processing any additional model forecast nodes, combination nodes, and selection nodes until a combined forecast for the one or more physical process attributes is generated at the root node.

2. The method of claim 1, wherein a node forecast is generated using a model associated with the model forecast node.

3. The method of claim 2, wherein metadata is associated with the model, wherein processing a selection node includes selecting the node forecast based on the metadata associated with the model.

4. The method of claim 3, wherein the metadata identifies a model characteristic of the associated model, wherein the node forecast is selected or not selected based on a match of the model characteristic with a characteristic of one of the physical process attributes.

5. The method of claim 4, wherein the model characteristic is selected from the group consisting of trending, seasonal, intermittent, and transformed.

6. The method of claim 1, wherein a node forecast for one of the physical process attributes includes a plurality of time series forecasts for one or more of the physical process attributes, wherein each of the time series forecasts is associated with a time or time period.

7. The method of claim 6, wherein processing a selection node includes determining an absence of an expected time series forecast during a time period of interest for a node forecast of a child node of the selection node;
wherein the node forecast is not selected based on the absence of the expected time series forecast.

8. The method of claim 6, wherein processing a selection node includes determining a statistic of fit for the plurality of time series forecasts of a node forecast, wherein a node forecast is selected based on the statistic of fit.

9. The method of claim 1, wherein processing a combination node includes:
assigning weights to each of the child nodes of the combination node;
multiplying a node forecast at a child node by a weight assigned to the child node to generate a weighted node forecast at the child node;
summing weighted time series forecasts of the children nodes of the combination node to generate a combined forecast.

10. The method of claim 9, wherein the weights are a weight type selected from the group consisting of: a simple average, user-defined weights, rank weights, ranked user-weights, AICC weights, root mean square error weights, restricted least squares weights, OLS weights, and least absolute deviation weights.

11. The method of claim 1, wherein processing a selection node includes determining a redundancy factor of a node forecast of a child node, wherein a node forecast is not selected based on the redundancy factor.

12. The method of claim 1, wherein one or more of the node forecasts for one of the physical process attributes are generated by a person.

13. The method of claim 1, further comprising calculating a prediction error for the combined forecast based on a plurality of node forecast errors.

14. The method of claim 1, wherein a selection node is processed prior to processing of a combination node.

15. One or more computer-readable storage mediums for storing data structures for access by an application program being executed on one or more data processors for evaluating a physical process with respect to one or more attributes of the physical process by combining forecasts for the one or more physical process attributes, wherein physical process data generated over time is used in the forecasts for the one or more physical process attributes, the data structures that are stored in the one or more computer-readable storage mediums comprising:
a predictive models data structure, the predictive models data structure containing predictive data model records for specifying predictive data models;
a forecast model selection graph data structure, wherein the forecast model selection graph data structure contains data about a hierarchical structure of nodes which specify how the forecasts for the one or more physical process attributes are combined, wherein the hierarchical structure of nodes has a root node, and wherein the nodes include model forecast nodes, one or more model combination nodes, and one or more model selection nodes;
wherein the forecast model selection graph data structure includes:
model forecast node data which specifies, for the model forecast nodes, which particular predictive data models contained in the predictive models data structure are to be used for generating forecasts;
model combination node data which specifies, for the one or more model combination nodes, which of the forecasts generated by the model forecast nodes are to be combined;
selection node data which specifies, for the one or more model selection nodes, model selection criteria for selecting, based upon model forecasting performance, models associated with the model forecast nodes or the one or more model combination nodes.

16. The one or more computer-readable storage mediums of claim 15, wherein the one or more computer-readable storage mediums include non-volatile storage, volatile storage, and combinations thereof.

17. The one or more computer-readable storage mediums of claim 15, wherein a first predictive data model record contains fields for specifying type of a first predictive data model and parameter values of the first predictive data model.

18. The one or more computer-readable storage mediums of claim 15, wherein a model forecast node data specifies for a model forecast node which particular predictive data model contained in the predictive models data structure is to be used for forecasting by providing an index specifying the particular predicative data model.

19. A computer-implemented system for evaluating a physical process with respect to one or more attributes of the physical process by combining forecasts for the one or more physical process attributes, where data for evaluating the physical process is generated over time, comprising:
one or more processors;
one or more computer-readable storage media containing instructions configured to cause the one or more processors to perform operations including:
accessing a forecast model selection graph, the forecast model selection graph comprising a hierarchy of nodes arranged in parent-child relationships including a root node, the nodes including a selection node, a combination node, and a plurality of model forecast nodes;
resolving the plurality of model forecast nodes, resolving a model forecast node including generating a node forecast for the one or more physical process attributes;
processing a combination node, a combination node transforming a plurality of node forecasts at child nodes of the combination node into a combined forecast;
processing a selection node, a selection node choosing a node forecast from among child nodes of the selection node based on a selection criteria; and
processing additional model forecast nodes, combination nodes, and selection nodes until a combined forecast for the one or more physical process attributes is generated at the root node.

20. A computer program product for providing row-level security, tangibly embodied in a machine-readable storage medium, including instructions configured to cause a data processing system to:
access a forecast model selection graph, the forecast model selection graph comprising a hierarchy of nodes arranged in parent-child relationships including a root node, the nodes including a selection node, a combination node, and a plurality of model forecast nodes;
resolve the plurality of model forecast nodes, resolving a model forecast node including generating a node forecast for the one or more physical process attributes;
process a combination node, a combination node transforming a plurality of node forecasts at child nodes of the combination node into a combined forecast;
process a selection node, a selection node choosing a node forecast from among child nodes of the selection node based on a selection criteria; and
process additional model forecast nodes, combination nodes, and selection nodes until a combined forecast for the one or more physical process attributes is generated at the root node.
